(19) United States
(12) Patent Application Publication
(10) Pub. No.: US 2024/0353847 A1
(43) Pub. Date: Oct. 24, 2024

(54) CONTROL SYSTEM, CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Takumi SAKAMOTO, Toyota-shi (JP); Shiro Oda, Anjo-shi (JP); Takeshi Matsui, Nisshin-shi (JP)

(73) Assignee: TOYOTA JIDOSHA KABUSHIKI KAISHA, Toyota-shi (JP)

(21) Appl. No.: 18/589,932

(22) Filed: Feb. 28, 2024

(30) Foreign Application Priority Data
Apr. 19, 2023 (JP) 2023-068271

(51) Int. Cl. G05D 1/221; B25J 5/00; B25J 9/16; G06F 3/0338

(52) U.S. Cl. CPC G05D 1/221; B25J 5/007; B25J 9/1689; B25J 9/1697; G06F 3/0338

(57) ABSTRACT

A control system includes one or more processors configured to execute system control of controlling a system including a mobile robot that includes a contact portion configured to come into contact with a transport object in a case where the transport object is mounted and transported, and is configured to move based on a movement operation received by an operation interface. The system control includes light emission control of causing a light emission unit including a first light emission unit disposed in a surrounding of the contact portion and a second light emission unit disposed on or in a surrounding of the operation interface, to emit light in different light emission patterns associated with each of a plurality of predetermined conditions. The light emission control includes control of linking a light emission pattern in the first light emission unit with a light emission pattern in the second light emission unit.

### CROSS-REFERENCE TO RELATED APPLICATION

This application claims priority to Japanese Patent Application No. 2023-068271 filed on Apr. 19, 2023, incorporated herein by reference in its entirety.

### BACKGROUND

### 1. Technical Field

The present disclosure relates to a control system, a control method, and a non-transitory storage medium.

### 2. Description of Related Art

Japanese Unexamined Patent Application Publication No. 2022-166397 (JP 2022-166397 A) discloses a control system for a mobile robot that can autonomously move.

### SUMMARY

The present inventors have examined that a mobile robot that autonomously moves and transports a transport object is provided with an operation interface that receives a movement operation from a user. In the mobile robot having such a configuration, there is a problem that a type of information that needs to be visually recognized by the user and the surrounding of the mobile robot is increased. Therefore, development of a system that enables the user or the surrounding of the mobile robot to visually recognize needed information in an easy-to-understand manner is desired. The problem cannot be solved with the technique described in JP 2022-166397 A.

The present disclosure provides a control system, a control method, and a non-transitory storage medium that enable a mobile robot being configured to autonomously move and transport a transport object, to receive a movement operation by a user from an operation interface, and then enable the user and the surrounding of the mobile robot to visually recognize needed information in an easy-to-understand manner.

A first aspect of the present disclosure relates to a control system configured to execute system control of controlling a system including a mobile robot configured to autonomously move and transport a transport object. The mobile robot is provided with a contact portion configured to come into contact with the transport object in a case where the transport object is mounted and transported, and is configured to move based on a movement operation received by an operation interface. The control system includes one or more processors. The one or more processors are configured to execute the system control. The system control includes light emission control of causing a light emission unit including a first light emission unit disposed in a surrounding of the contact portion and a second light emission unit disposed on the operation interface or in a surrounding of the operation interface, to emit light in different light emission patterns associated with each of a plurality of predetermined conditions. The light emission control includes control of linking a first light emission pattern that is a light emission pattern in the first light emission unit with a second light emission pattern that is a light emission pattern in the second light emission unit. With such a configuration, the control system enables the mobile robot being configured to autonomously move and transport the transport object, to receive the movement operation by the user from the operation interface, and then enables the user and the surrounding of the mobile robot to visually recognize the needed information in an easy-to-understand manner. In control of the autonomous movement, the mobile robot can also be caused to autonomously move by using a learning model obtained by machine learning.

In the first aspect of the present disclosure, the light emission control may include synchronization control of emitting light in the first light emission pattern and the second light emission pattern that are associated with a first condition among the predetermined conditions synchronously with each other. The light emission control may include first asynchronization control of emitting light in the first light emission pattern associated with a second condition among the predetermined conditions asynchronously with the second light emission pattern. The light emission control may include second asynchronization control of emitting light in the second light emission pattern associated with a third condition among the predetermined conditions asynchronously with the first light emission pattern. With such a configuration, the control system enables switching between methods for transmission of the information by, for example, executing the asynchronization control and the synchronization control when the information is desired to be separately transmitted and when the information is not desired to be separately transmitted, respectively.

In the first aspect of the present disclosure, the light emission control may include control of switching between the synchronization control, the first asynchronization control, and the second asynchronization control in accordance with the predetermined conditions. With such a configuration, the control system enables automatic switching between the synchronization control, the first asynchronization control, and the second asynchronization control in accordance with the predetermined conditions.

In the first aspect of the present disclosure, the system control may include control of changing the first condition, the second condition, and the third condition. With such a configuration, the control system enables the change of the conditions for executing the synchronization control, the first asynchronization control, and the second asynchronization control, for example, in order to correspond to a traveling environment of the mobile robot.

In the first aspect of the present disclosure, the system control may include control of changing the first light emission pattern and the second light emission pattern used in each of the synchronization control, the first asynchronization control, and the second asynchronization control. With such a configuration, the control system enables automatic change of the light emission patterns expressed by each of the synchronization control, the first asynchronization control, and the second asynchronization control in accordance with the traveling environment of the mobile robot or a sensing result of a sensor, or change of the light emission patterns in accordance with a user operation.

In the first aspect of the present disclosure, the synchronization control may be control of emitting light such that the first light emission pattern and the second light emission pattern are light emission patterns having a mutual complementary relationship. With such a configuration, the control system enables the light emission that is likely to be noticed by the user in a case of the synchronization control.

In the first aspect of the present disclosure, the operation interface may be provided in the mobile robot. The one or more processors may be included in a controller provided in the operation interface, or may be included in a controller provided in a portion of the mobile robot other than the operation interface, or may be included in a server provided as a part of the system to be connected to the mobile robot through wireless communication. With such a configuration, the control system enables the execution of the light emission control corresponding to various system configurations, such as a configuration in which the mobile robot is operated, from the mobile robot.

In the first aspect of the present disclosure, the operation interface may be a remote operation device configured to be connected to the mobile robot through wireless communication. The one or more processors may be configured to execute the light emission control based on a control signal output by a controller provided in the remote operation device for the light emission control, or the one or more processors may be included in a controller provided in the mobile robot or a server provided as a part of the system to be connected to the mobile robot through wireless communication. With such a configuration, the control system enables the execution of the light emission control corresponding to various system configurations, such as a configuration in which the mobile robot is remotely operated.

In the first aspect of the present disclosure, the operation interface may be a joystick device. With such a configuration, the control system enables intuitive execution of the movement operation of the mobile robot, and then enables the user and the surrounding of the mobile robot to visually recognize the needed information in an easy-to-understand manner.

A second aspect of the present disclosure relates to a control method of executing system control of controlling a system including a mobile robot configured to autonomously move and transport a transport object. The mobile robot is provided with a contact portion configured to come into contact with the transport object in a case where the transport object is mounted and transported, and is configured to move based on a movement operation received by an operation interface. The system control includes light emission control of causing a light emission unit including a first light emission unit disposed in a surrounding of the contact portion and a second light emission unit disposed on the operation interface or in a surrounding of the operation interface, to emit light in different light emission patterns associated with each of a plurality of predetermined conditions. The light emission control includes control of linking a first light emission pattern that is a light emission pattern in the first light emission unit with a second light emission pattern that is a light emission pattern in the second light emission unit. With such a configuration, the control method enables the mobile robot being configured to autonomously move and transport the transport object, to receive the movement operation by the user from the operation interface, and then enables the user and the surrounding of the mobile robot to visually recognize the needed information in an easy-to-understand manner.

In the second aspect of the present disclosure, the light emission control may include synchronization control of emitting light in the first light emission pattern and the second light emission pattern that are associated with a first condition among the predetermined conditions synchronously with each other. The light emission control may include first asynchronization control of emitting light in the first light emission pattern associated with a second condition among the predetermined conditions asynchronously with the second light emission pattern. The light emission control may include second asynchronization control of emitting light in the second light emission pattern associated with a third condition among the predetermined conditions asynchronously with the first light emission pattern. With such a configuration, the control method enables switching between transmission methods of the information by, for example, executing the asynchronization control and the synchronization control when the information is desired to be separately transmitted and when the information is not desired to be separately transmitted, respectively.

In the second aspect of the present disclosure, the light emission control may include control of switching between the synchronization control, the first asynchronization control, and the second asynchronization control in accordance with the predetermined conditions. With such a configuration, the control method enables automatic switching between the synchronization control, the first asynchronization control, and the second asynchronization control in accordance with the predetermined conditions.

In the second aspect of the present disclosure, the system control may include control of changing the first condition, the second condition, and the third condition. With such a configuration, the control method enables the change of the conditions for executing the synchronization control, the first asynchronization control, and the second asynchronization control, for example, in order to correspond to a traveling environment of the mobile robot.

In the second aspect of the present disclosure, the system control may include control of changing the first light emission pattern and the second light emission pattern used in each of the synchronization control, the first asynchronization control, and the second asynchronization control. With such a configuration, the control method enables automatic change of the light emission patterns expressed by each of the synchronization control, the first asynchronization control, and the second asynchronization control in accordance with the traveling environment of the mobile robot or a sensing result of a sensor, or change of the light emission patterns in accordance with a user operation.

In the second aspect of the present disclosure, the synchronization control may be control of emitting light such that the first light emission pattern and the second light emission pattern are light emission patterns having a mutual complementary relationship. With such a configuration, the control method enables the light emission that is likely to be noticed by the user in a case of the synchronization control.

In the second aspect of the present disclosure, the operation interface may be provided in the mobile robot. A controller provided in the operation interface, a controller provided in a portion of the mobile robot other than the operation interface, or a server provided as a part of the system to be connected to the mobile robot through wireless communication may output a control signal for the light emission control. With such a configuration, the control method enables the execution of the light emission control corresponding to various system configurations, such as a configuration in which the mobile robot is operated, from the mobile robot.

In the second aspect of the present disclosure, the operation interface may be a remote operation device configured to be connected to the mobile robot through wireless communication. The light emission control may be executed based on a control signal output by a controller provided in the remote operation device for the light emission control, or a controller provided in the mobile robot or a server provided as a part of the system to be connected to the mobile robot through wireless communication may output a control signal for the light emission control. With such a configuration, the control method enables the execution of the light emission control corresponding to various system configurations, such as a configuration in which the mobile robot is remotely operated.

In the second aspect of the present disclosure, the operation interface may be a joystick device. With such a configuration, the control method enables intuitive execution of the movement operation of the mobile robot, and then enables the user and the surrounding of the mobile robot to visually recognize the needed information in an easy-to-understand manner.

A third aspect of the present disclosure relates to a non-transitory storage medium storing instructions that are executable by one or more processors and that cause the one or more processors to execute system control of controlling a system including a mobile robot configured to autonomously move and transport a transport object. The mobile robot is provided with a contact portion configured to come into contact with the transport object in a case where the transport object is mounted and transported, and is configured to move based on a movement operation received by an operation interface. The system control includes light emission control of causing a light emission unit including a first light emission unit disposed in a surrounding of the contact portion and a second light emission unit disposed on the operation interface or in a surrounding of the operation interface, to emit light in different light emission patterns respectively with each of a plurality of predetermined conditions. The light emission control includes control of linking a first light emission pattern that is a light emission pattern in the first light emission unit with a second light emission pattern that is a light emission pattern in the second light emission unit. With such a configuration, the non-transitory storage medium enables the mobile robot being configured to autonomously move and transport the transport object, to receive the movement operation by the user from the operation interface, and then enables the user and the surrounding of the mobile robot to visually recognize the needed information in an easy-to-understand manner.

In the third aspect of the present disclosure, the light emission control may include synchronization control of emitting light in the first light emission pattern and the second light emission pattern that are associated with a first condition among the predetermined conditions synchronously with each other. The light emission control may include first asynchronization control of emitting light in the first light emission pattern associated with a second condition among the predetermined conditions asynchronously with the second light emission pattern. The light emission control may include second asynchronization control of emitting light in the second light emission pattern associated with a third condition among the predetermined conditions asynchronously with the first light emission pattern. With such a configuration, the non-transitory storage medium enables switching between transmission methods of the information by, for example, executing the asynchronization control and the synchronization control when the information is desired to be separately transmitted and when the information is not desired to be separately transmitted, respectively.

In the third aspect of the present disclosure, the light emission control may include control of switching between the synchronization control, the first asynchronization control, and the second asynchronization control in accordance with the predetermined conditions. With such a configuration, the non-transitory storage medium enables the automatic switching between the synchronization control, the first asynchronization control, and the second asynchronization control in accordance with the predetermined conditions.

In the third aspect of the present disclosure, the system control may include control of changing the first condition, the second condition, and the third condition. With such a configuration, the non-transitory storage medium enables the change of the conditions for executing the synchronization control, the first asynchronization control, and the second asynchronization control, for example, in order to correspond to a traveling environment of the mobile robot.

In the third aspect of the present disclosure, the system control may include control of changing the first light emission pattern and the second light emission pattern used in each of the synchronization control, the first asynchronization control, and the second asynchronization control. With such a configuration, the non-transitory storage medium enables automatic change of the light emission patterns expressed by each of the synchronization control, the first asynchronization control, and the second asynchronization control in accordance with the traveling environment of the mobile robot or a sensing result of a sensor, or change of the light emission patterns in accordance with a user operation.

In the third aspect of the present disclosure, the synchronization control may be control of emitting light such that the first light emission pattern and the second light emission pattern are light emission patterns having a mutual complementary relationship. With such a configuration, the non-transitory storage medium enables the light emission that is likely to be noticed by the user in a case of the synchronization control.

In the third aspect of the present disclosure, the operation interface may be provided in the mobile robot. The one or more processors may be included in a controller provided in the operation interface, or may be included in a controller provided in a portion of the mobile robot other than the operation interface, or may be included in a server provided as a part of the system to be connected to the mobile robot through wireless communication. With such a configuration, the non-transitory storage medium enables the execution of the light emission control corresponding to various system configurations, such as a configuration in which the mobile robot is operated, from the mobile robot.

In the third aspect of the present disclosure, the operation interface may be a remote operation device configured to be connected to the mobile robot through wireless communication. The one or more processors may be configured to execute the light emission control based on a control signal output by a controller provided in the remote operation device for the light emission control, or the one or more processors may be included in a controller provided in the mobile robot or a server provided as a part of the system to be connected to the mobile robot through wireless communication. With such a configuration, the non-transitory storage medium enables the execution of the light emission control corresponding to various system configurations, such as a configuration in which the mobile robot is remotely operated.

In the third aspect of the present disclosure, the operation interface may be a joystick device. With such a configuration, the non-transitory storage medium enables intuitive execution of the movement operation of the mobile robot, and then enables the user and the surrounding of the mobile robot to visually recognize the needed information in an easy-to-understand manner.

The present disclosure can provide the control system, the control method, and the non-transitory storage medium that enable the mobile robot being configured to autonomously move and transport the transport object, to receive the movement operation by the user from the operation interface, and then enable the user and the surrounding of the mobile robot to visually recognize the needed information in an easy-to-understand manner.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view illustrating an overall configuration example of a mobile robot according to an embodiment;

FIG. 2 is a perspective view illustrating an overall configuration example of a wagon transported by the mobile robot of FIG. 1;

FIG. 3 is a perspective view illustrating a state where the wagon of FIG. 2 is transported by the mobile robot of FIG. 1;

FIG. 4 is a flowchart for describing an example of a light emission process executed by the mobile robot of FIG. 1;

FIG. 5 is a diagram illustrating an example of a light emission pattern that can be executed in the mobile robot of FIG. 1;

FIG. 6 is a flowchart for describing another example of the light emission process executed by the mobile robot of FIG. 1;

FIG. 7 is a diagram illustrating another example of the light emission pattern that can be executed in the mobile robot of FIG. 1;

FIG. 8 is a schematic diagram illustrating an overall configuration example of a system including the mobile robot according to the embodiment;

FIG. 9 is a flowchart for describing a process example in a host management device in the system of FIG. 8;

FIG. 10 is a perspective view illustrating an example of a joystick device that operates the mobile robot according to the embodiment;

FIG. 11 is a top view illustrating an example of an operation interface that operates the mobile robot according to the embodiment;

FIG. 12 is a top view illustrating another example of the operation interface that operates the mobile robot according to the embodiment; and

FIG. 13 is a diagram illustrating an example of a hardware configuration of a device.

### DETAILED DESCRIPTION OF EMBODIMENTS

Hereinafter, the present disclosure will be described with an embodiment of the present disclosure, but the present disclosure according to the claims is not limited to the following embodiment. In addition, all of the configurations described in the embodiment are not always needed as means for solving the problem.

### Embodiment

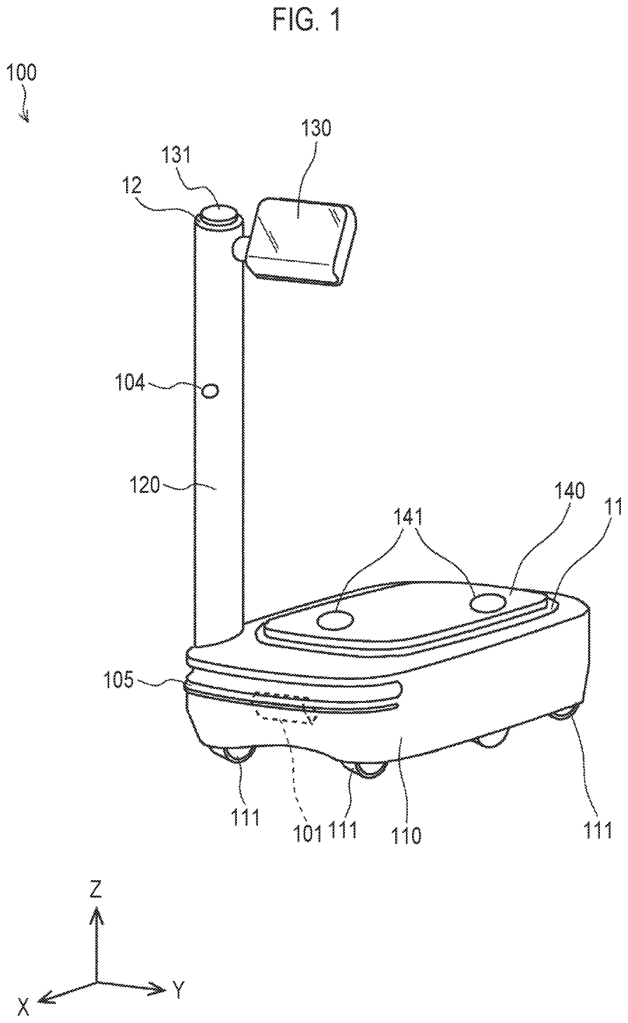

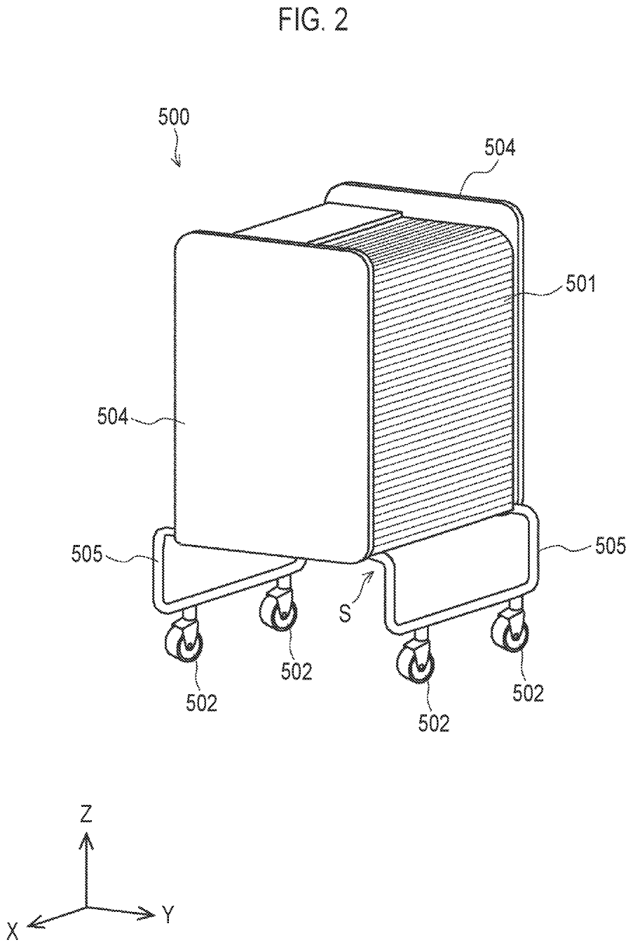

A control system according to the present embodiment is configured to execute system control of controlling a system including a mobile robot configured to autonomously move and transport a transport object. Since the mobile robot is configured to transport the transport object, the mobile robot can also be referred to as a transport robot, and the system can be referred to as a transport system. Hereinafter, a configuration example of the mobile robot according to the present embodiment will be described with reference to FIGS. 1 and 2. FIG. 1 is a perspective view illustrating an overall configuration example of the mobile robot according to the present embodiment, and FIG. 2 is a perspective view illustrating an overall configuration example of a wagon transported by the mobile robot of FIG. 1.

The transport system just needs to be provided with a mobile robot, such as a mobile robot 100 illustrated in FIG. 1, but can also be provided with another device, such as a host management device. Note that, for the sake of simplicity of description, first, a main feature of the mobile robot 100 will be described with an example in which the transport system is configured with the mobile robot 100 alone. In a case of this example, the control system can indicate the mobile robot 100 itself or components of a control system provided in the mobile robot 100.

In the following description, an XYZ orthogonal coordinate system will be used as appropriate for the description. An X direction is a front-rear direction of the mobile robot 100 illustrated in FIG. 1, a Y direction is a right-left direction, and a Z direction is a vertical up-down direction. More specifically, a +X direction is defined as a front direction of the mobile robot 100, and a −X direction is defined as a rear direction of the mobile robot 100. A+Y direction is a left direction of the mobile robot 100, and a −Y direction is a right direction of the mobile robot 100. A+Z direction is a vertical up direction, and a −Z direction is a vertical down direction.

The mobile robot 100 can move in both of the front direction and the rear direction. That is, with the forward rotation of the wheels, the mobile robot 100 moves in the front direction, and with the reverse rotation of the wheels, the mobile robot 100 moves in the rear direction. The mobile robot 100 can turn right and left by changing the rotation speed of the right and left wheels.

As illustrated in FIG. 1, the mobile robot 100 can be provided with a chassis 110 on which the transport object is mounted, a stand 120, and an operation unit 130. Wheels 111, an axle, a battery, a control computer 101, a drive motor, and the like are mounted on the chassis 110. The description will be made on the premise that the control computer 101 is mounted on the chassis 110 at a position illustrated in the drawing, but the present disclosure is not limited to this configuration, and the control computer 101 can also be mounted on the chassis 110 at another position, or a part or entirety of the control computer 101 can also be mounted at least one of the stand 120 and the operation unit 130.

The chassis 110 rotatably holds the wheels 111. In the example of FIG. 1, the chassis 110 is provided with four wheels 111. The four wheels 111 are right and left front wheels, and right and left rear wheels. Then, the mobile robot 100 moves by a desired route by independently controlling a rotation direction and a rotation speed of the wheels 111. A part of the four wheels 111 may be driving wheels, and the rest may be driven wheels. In addition, as illustrated in FIG. 1, an additional driven wheel can also be provided between the front and rear wheels 111 or the like.

Further, at least one of the chassis 110, the operation unit 130, and the stand 120 may be provided with, for example, various sensors, such as a camera and a distance measurement sensor, to prevent contact with an obstacle or to check the route.

FIG. 1 illustrate an example in which, as the sensors, the camera 104 directed to a +X side is provided in the stand 120 and a sensor 105 is provided in a front portion of the chassis 110. A bumper is provided in the front portion of the chassis 110, and the sensor 105 can be disposed on the bumper and senses that an object comes into contact with the bumper. The mobile robot 100 can execute control of stopping the mobile robot 100 in a case where the sensor 105 senses the contact with the object, that is, the obstacle. Accordingly, the sensor 105 can be referred to as a stop sensor. Note that the sensor 105 is not limited to the sensor provided in the front portion, and can also be a sensor that is provided in a part or entirety of the outer periphery of the mobile robot 100, to sense the contact of the object with the bumper. In addition, the sensor 105 can also be configured to sense a position on the provided bumper with which the object comes into contact.

The mobile robot 100 is an autonomous movement robot that has a function of being movable by the operation of the user, that is, is a mobile robot that can switch between an autonomous movement mode and a user operation mode. With the control of the autonomous movement, the mobile robot 100 can execute the autonomous movement based on the route decided or set in accordance with the set transport destination. In the control of the autonomous movement, the mobile robot 100 can also be caused to autonomously move by deciding the route or executing contact avoidance by using a learning model obtained by machine learning.

Here, the user operation mode in which the movement is executed based on the user operation just needs to be a mode in which a degree of involvement of the user operation is relatively high with respect to the autonomous movement mode in which the autonomous movement is executed. That is, the user operation mode does not have to be limited to a mode in which the user operates all of the motions of the mobile robot and eliminates all the autonomous control via the mobile robot, and similarly, the autonomous movement mode does not have to be limited to a mode in which full autonomous control is executed by the mobile robot and the operation of the user is not received at all. For example, the user operation mode and the autonomous movement mode may include first to third examples described below.

In the first example, in the autonomous movement mode, the mobile robot autonomously travels and determines whether to stop or start traveling without the operation of the user, and in the user operation mode, the mobile robot autonomously travels and the user executes operations of stopping and starting traveling. In the second example, in the autonomous movement mode, the mobile robot autonomously travels and the user executes the operation of stopping and starting travel, and in the user operation mode, the mobile robot does not autonomously travel and the user executes a traveling operation in addition to the operations of stopping and starting traveling. In the third example, in the autonomous movement mode, the mobile robot autonomously travels and determines whether to stop or start traveling without the operation of the user, and in the user operation mode, the mobile robot autonomously travels for speed adjustment, contact avoidance, or the like and the user executes an operation, such as changing a traveling direction or the route.

In addition, the user can be, for example, a worker at the facility in which the mobile robot 100 is practically used, and in a case where the facility is the hospital, the user can be a hospital worker.

For example, the control computer 101 can be realized by an integrated circuit, and can be realized by, for example, a processor, such as a microprocessor unit (MPU) or a central processing unit (CPU), a work memory, and a non-transitory storage medium. A control program to be executed by the processor is stored in the non-transitory storage medium, and the processor can perform a function of controlling the mobile robot 100 by reading out the program into the work memory and executing the program. The control computer 101 can be referred to as a controller. The control computer 101 may include a plurality of processors.

The control computer 101 executes, based on map data stored in advance and information acquired by various sensors illustrated by the camera 104, autonomous movement control on the mobile robot 100 such that the mobile robot 100 moves toward the transport destination set in advance or along the transport route set in advance. In addition, the autonomous movement control can include control of mounting the wagon 500 illustrated in FIG. 2 or control of unloading the wagon 500. The wagon 500 will be described below. The control computer 101 can be provided with a movement controller that executes such autonomous movement control.

In order to load and unload the transport object, such as the wagon 500, the chassis 110 can be provided with a raising/lowering mechanism 140 for loading and unloading the transport object. The raising/lowering mechanism 140 can be partially accommodated inside the chassis 110 and can be disposed on an upper surface side of the chassis 110 in a state where a contact portion that comes into contact with a bottom surface of the transport object by linking, connection, or the like in a case where the transport object is mounted and transported is exposed. The raising/lowering mechanism 140 is a raising/lowering stage that can be raised and lowered, and can be raised and lowered in accordance with the control from the control computer 101. The chassis 110 is provided with a raising/lowering motor or a guide mechanism. An upper surface of the raising/lowering mechanism 140 is the contact portion on which the wagon 500 as the transport object is placed. That is, the contact portion can be the upper surface of the raising/lowering mechanism 140. The wagon 500 is not limited to the configuration illustrated in FIG. 2, and just needs to be a predetermined wagon having a size, a shape, and a weight with which the mounting on the raising/lowering mechanism 140 and the transport is possible. The raising/lowering mechanism 140 includes a lift mechanism that lifts the wagon 500. A space above the raising/lowering mechanism 140 serves as a mounting space on which the transport object is mounted. In a case where the practical use is limited to the loading of the wagon 500 via the user, the chassis 110 does not have to be provided with the raising/lowering mechanism 140.

In addition, the chassis 110 can be provided with a first light emission unit 11 at a position surrounding the raising/lowering mechanism 140, that is, surrounding the contact portion. The first light emission unit 11 just needs to have a configuration in which light can be emitted and can be configured with, for example, one or more light-emitting diodes (LEDs) or an organic electroluminescence, and the light emission can be controlled by the control computer 101. In addition, a position, a shape, or a size of the first light emission unit 11 is not limited to the illustrated position, shape, or size. Even in a case where the raising/lowering mechanism 140 is not provided, the mobile robot 100 is provided with the contact portion that comes into contact with the transport object in a case where the transport object is mounted and transported, and the first light emission unit 11. The first light emission unit 11 and a second light emission unit 12 described below are merely given the prefixes “first” and “second” to distinguish the first light emission unit 11 and the second light emission unit 12 from each other.

The stand 120 is attached to the chassis 110. The stand 120 is a rod-shaped member extending upward from the chassis 110. Here, the stand 120 is formed in a cylindrical shape with the Z direction as a longitudinal direction, but of course, the shape does not matter, and a configuration in which the mobile robot 100 is not provided with the stand 120 may be adopted. The longitudinal direction of the stand 120 is provided to be parallel to the Z direction. The stand 120 is disposed outside the raising/lowering mechanism 140. That is, the stand 120 is disposed so as not to interfere with a raising/lowering operation of the raising/lowering mechanism 140. The stand 120 is disposed on one end side of the chassis 110 in the Y direction (right-left direction). The stand 120 is attached to the vicinity of a right front corner portion of the chassis 110. In an XY plane, the stand 120 is provided at an end portion of the chassis 110 on the +X side and a −Y side.

In addition, the stand 120 can be provided with a stick portion (stick member) 131 as a component of the joystick device that is an example of an operation interface according to the present embodiment, on the upper surface portion. The joystick device is a device that executes a movement operation of causing the mobile robot 100 to move in a direction intended by the user in the user operation mode, and the movement operation can be receive by the stick portion 131. On the stick portion 131, for example, the user can execute the movement operation by moving a hand in a desired direction in a state where the upper portion of the stick portion 131 is wrapped with a palm of the hand of the user. The stick portion 131 can also be referred to as a grip portion. The shape or the size of the stick portion 131 is not limited to the illustrated shape or size, and for example, the stick portion 131 may have a longer shape in a Z-axis direction, thereby enabling the user to grip the stick portion by the hand. Of course, the shape or the size of the joystick device including the stick portion 131 is not limited to the shape or the size illustrated in the drawing.

The user can tilt the stick portion 131 in a direction desired to move so a direction operation can be received. In addition, the joystick device can also control to execute the switching operation of switching between the autonomous movement mode and the user operation mode, by pressing the stick portion 131 downward. Alternatively, the joystick device can also control to execute the decision operation, by pressing the stick portion 131 downward. In addition, the stick portion 131 can also be configured to play a role of an emergency stop button for emergency stopping the mobile robot 100 by being pressed downward for a predetermined period. In a case of the configuration in which the plurality of operations of the switching operation, the decision operation, and the emergency stop operation can be received, the predetermined period just needs to be differentiated for each operation.

In addition, the stand 120 can be provided with the second light emission unit 12 at a position surrounding the stick portion 131. The second light emission unit 12 just needs to have a configuration in which light can be emitted and can be configured with, for example, one or more LEDs or an organic electroluminescence, and the light emission can be controlled by the control computer 101. In addition, a position, a shape, or a size of the second light emission unit 12 is not limited to the illustrated position, shape, or size. Even in a case where the stand 120 is not provided or in a case where the stand 120 is provided but the stick portion 131 is not provided, the mobile robot 100 is provided with the second light emission unit 12.

The stand 120 supports the operation unit 130. The operation unit 130 is attached to the vicinity of an upper end of the stand 120. Therefore, the operation unit 130 can be installed at a height for the user to easily execute the operation. That is, the stand 120 extends to a height for the user in a standing state to easily execute the operation, and the stick portion 131 is also disposed at a height for the user to easily execute the operation. The operation unit 130 extends to a +Y side from the stand 120. In terms of easy operation, the operation unit 130 can be disposed in the center of the chassis 110 in the right-left direction.

The operation unit 130 can be provided with a touch panel monitor or the like that receives the operation of the user. Of course, the operation unit 130 can also be provided with a microphone or the like for voice input. The monitor of the operation unit 130 faces a side opposite to the chassis 110. That is, a display surface (operation surface) of the operation unit 130 is a surface on the +X side. The operation unit 130 may be detachably provided in the stand 120. That is, the stand 120 may be attached with a holder that holds a touch panel. The user can input the transport destination of the transport object, transport information on the transport object, or the like by operating the operation unit 130. Further, the operation unit 130 can display, to the user, information, such as the contents of the transport object being transported, the transport object scheduled to be transported, or the destination. Of course, the mobile robot 100 may have a configuration in which the operation unit 130 is not provided, but even in such a case, the mobile robot 100 can also have a configuration in which the joystick device is provided and the operation in the user operation mode is possible. For example, the mobile robot 100 has a configuration in which the joystick device or the like can be operated in the user operation mode. In addition, the mobile robot 100 can also be connected to a remote operation device that executes a remote operation, and the remote operation device can also be the joystick device.

In addition, as illustrated in the drawing, the operation unit 130 and the stick portion 131 can be disposed at least at the same height such that the operation unit 130 and the stick portion 131 can be operated intuitively. Therefore, even in a case where a pressing operation with the stick portion 131 is assigned to an operation of deciding an operation content displayed on the operation unit 130, the user can execute the operation with an intuitive flow.

In addition, an integrated circuit (IC) card reader for the user to execute user authentication using an IC card or the like can be provided at a position in the stand 120 with the same height as the operation unit 130 or inside the operation unit 130. The mobile robot 100 does not have to have a user authentication function, but can block an operation caused by a third party's prank or the like in a case where the user authentication function is provided. The user authentication function is not limited to the function using the IC card, and a method of inputting user information and a password from the operation unit 130 may be adopted, but the time and effort of the user can be reduced or the infection is prevented by adopting a method using various short-range wireless communication techniques capable of executing non-contact authentication.

With respect to the mobile robot 100, the user can accommodate the transport object in the wagon 500 mounted on the mobile robot 100 and request the transport. Hereinafter, since the wagon 500 itself can also be referred to as the transport object, for convenience, the description will be made by referring the transport object accommodated in the wagon 500 as an article for distinction. The mobile robot 100 autonomously moves to the set destination and transports the wagon 500. That is, the mobile robot 100 executes the transport task for the wagon 500. In the following description, a location in which the wagon 500 is mounted will also be referred to as the transport source or a loading location, and a location to which the wagon 500 is delivered will also be referred to as the transport destination or the destination.

For example, the mobile robot 100 moves inside a general hospital having a plurality of clinical departments. The mobile robot 100 transports the article, such as equipment, a consumable, or a medical instrument, between the clinical departments. For example, the mobile robot 100 delivers the article from a nurse station of one clinical department to a nurse station of another clinical department. Alternatively, the mobile robot 100 delivers the article from a storage depository of the equipment or the medical instrument to the nurse station of the clinical department. In addition, the mobile robot 100 delivers medicine prepared in a medicine preparation department to the clinical department or a patient scheduled to use the medicine.

Examples of the article include the consumable, such as an agent and a bandage, and the equipment, such as a sample, an examination instrument, a medical instrument, hospital food, and stationery. Examples of the medical instrument include a sphygmomanometer, a transfusion pump, a syringe pump, a foot pump, a nurse call button, a bed exit sensor, a low-pressure continuous inhaler electrocardiograph monitor, a medicine injection controller, an enteral feeding pump, an artificial respirator, a cuff pressure meter, a touch sensor, an aspirator, a nebulizer, a pulse oximeter, an artificial ventilation device, an asepsis device, and an echocardiographic device. In addition, food, such as hospital food and examination food, may be transported. Further, the mobile robot 100 may transport a used device, a used tableware, and the like. In a case where the transport destinations are located on different floors, the mobile robot 100 may move by using an elevator or the like.

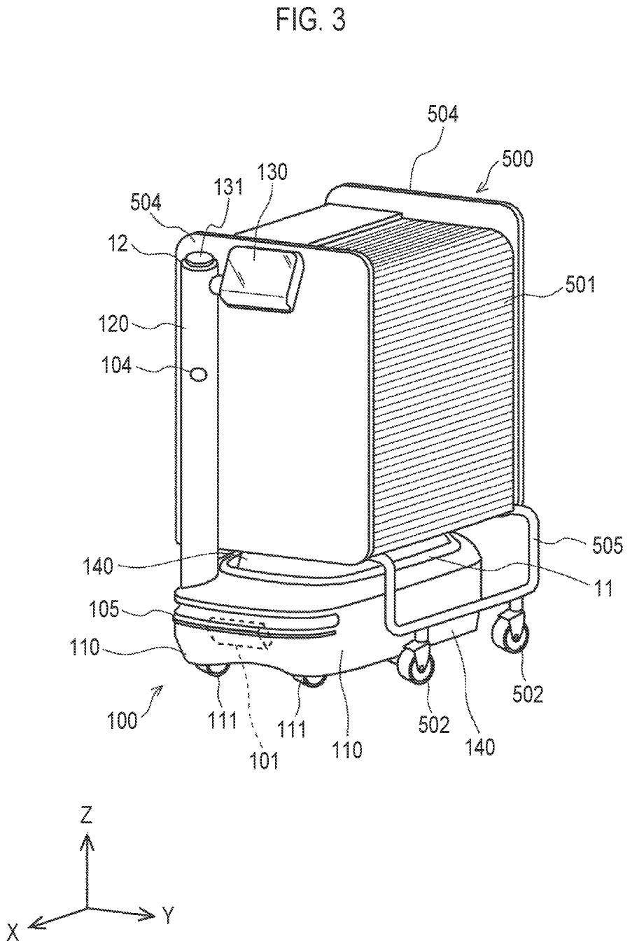

Next, the details of the wagon 500 and an example of holding the wagon 500 via the mobile robot 100 will be described with reference to FIGS. 2 and 3. FIG. 3 is a perspective view illustrating a state where the wagon 500 is transported by the mobile robot 100.

The wagon 500 is provided with an accommodation portion that accommodates the article and a support portion that supports the accommodation portion in a state where a space in which the entry of at least a part of the chassis 110 is allowed is formed on a lower side of the accommodation portion. As illustrated in FIG. 2, the accommodation portion can include side plates 504 on both sides of the wagon 500 and a cover 501 that can be opened and closed. When the user opens the cover 501, the user can load and unload the article accommodated inside the wagon 500. As illustrated in FIG. 2, the support portion can include a support frame 505 that supports the accommodation portion and wheels 502 attached to a lower side of the support frame 505. The wheels 502 can also be provided with covers (not illustrated).

As described above, the wagon 500 can be held by the raising/lowering mechanism 140 in the mobile robot 100. The raising/lowering mechanism 140 is a mechanism for loading and unloading the wagon 500 as the transport object on at least a part of the upper surface side of the chassis 110. Since the raising/lowering mechanism 140 is provided, the mobile robot 100 can easily automatically transport the wagon 500.

As illustrated in FIG. 3, the mobile robot 100 can hold the wagon 500 via the raising/lowering mechanism 140. The space in which the entry of at least a part of the chassis 110 is allowed is a space S formed on the lower side of the wagon 500 illustrated in FIG. 2, and the space S is a space in which the chassis 110 enters. That is, the chassis 110 can enter the space S directly under the wagon 500. In a case where the wagon 500 is mounted on the chassis 110, the mobile robot 100 moves in the −X direction and enters directly under the wagon 500. The chassis 110 enters directly under the wagon 500 from a side on which the stand 120 is not provided in the front-rear direction. In this manner, the wagon 500 can be mounted without the stand 120 interfering with the wagon 500. Stated another way, the stand 120 can be attached to the vicinity of the corner portion of the chassis 110 so as not to interfere with the wagon 500.

In addition, as illustrated in FIG. 1, a recess portion 141 can be provided in the contact portion that comes into contact with the bottom surface of the wagon 500 by linking, connection, or the like in a case where the wagon 500 is mounted and transported, in the raising/lowering mechanism 140. As described above, the contact portion can be the upper surface of the raising/lowering mechanism 140. On the other hand, a protrusion portion (not illustrated) can be provided on the lower side of the accommodation portion of the wagon 500. Then, by fitting the protrusion portion into the recess portion 141, the wagon 500 can be fixed to the mobile robot 100.

Although the wagon 500 is illustrated as a trolley provided with the wheels 502, the shape or the configuration of the wagon 500 is not particularly limited. The predetermined wagon illustrated by the wagon 500 just needs to have a shape, a size, and a weight with which the transport via the mobile robot 100 is possible.

An operation of the mobile robot 100 loading the wagon 500, transporting the wagon 500 to the transport destination, and unloading the wagon 500 will be described. First, for the loading of the wagon 500, the mobile robot 100 can be a mobile robot for which the wagon 500 is set in advance as a transport target and that moves in search of the wagon 500 or to a known position. For example, the mobile robot 100 can also autonomously move for transporting the wagon 500 by designating the wagon 500 of which the position is designated by the user, as the transport target or as a search target. Alternatively, the mobile robot 100 may automatically transport the wagon 500 to the transport destination in a case where the wagon 500 is found on a return route after the transport task of transporting another wagon or article is finished. Without limitation to these examples, various methods can be applied as a practical use method of transporting the wagon 500 via the mobile robot 100.

The mobile robot 100 moves to the position of the wagon 500, and the control computer 101 recognizes the wagon 500 based on the information acquired by the camera 104 or another sensor, and executes control of stacking the wagon 500 via the raising/lowering mechanism 140. The control of stacking can also be referred to as pick-up control.

In the pick-up control, first, the chassis 110 is allowed to enter the space S directly under the wagon 500, and the raising/lowering mechanism 140 is raised when the entry is completed. Therefore, the raising/lowering stage, as the upper surface of the raising/lowering mechanism 140, comes into contact with the wagon 500, and the raising/lowering mechanism 140 can lift the wagon 500. That is, when the raising/lowering mechanism 140 rises, the wheels 502 are separated from the ground, and the wagon 500 is mounted on the chassis 110. Therefore, the mobile robot 100 docks with the wagon 500 and is ready for moving toward the transport destination. Then, the control computer 101 transports the wagon 500 to the transport destination by controlling the driving of the wheels 111 or the like such that the autonomous movement is executed along the set route.

The mobile robot 100 moves to the transport destination of the wagon 500, and the control computer 101 executes control of unloading the wagon 500 via the raising/lowering mechanism 140. In this control, the raising/lowering mechanism 140 is lowered in order to unload the wagon 500 from the chassis 110. The wheels 502 come into contact with a floor surface, and the upper surface of the raising/lowering mechanism 140 is separated from the wagon 500. The wagon 500 is placed on the floor surface. The wagon 500 can be unloaded from the chassis 110.

In the various examples, the description is made on the premise that each of the mobile robots 100 transports the wagon, such as the wagon 500, as the transport object. Note that the mobile robot 100 may be configured not to transport the wagon, or may transport individual articles (packages) as the transport objects during practical use even in a configuration in which the wagon can be transported. In such a case, an accommodation box, a rack portion, or the like for preventing falling-off of the article during the movement may be attached to the mobile robot 100.

In addition, in terms of practical use, there may be a situation where a plurality of articles is transported by the mobile robot 100 and the articles need to be transported to a plurality of transport destinations. In this case, the user can unload the article at the transport destination regardless of whether or not the wagon 500 is used for transport. The mobile robot 100 can autonomously move to the set destination or move in accordance with the user operation, to transport the wagon or individual articles.

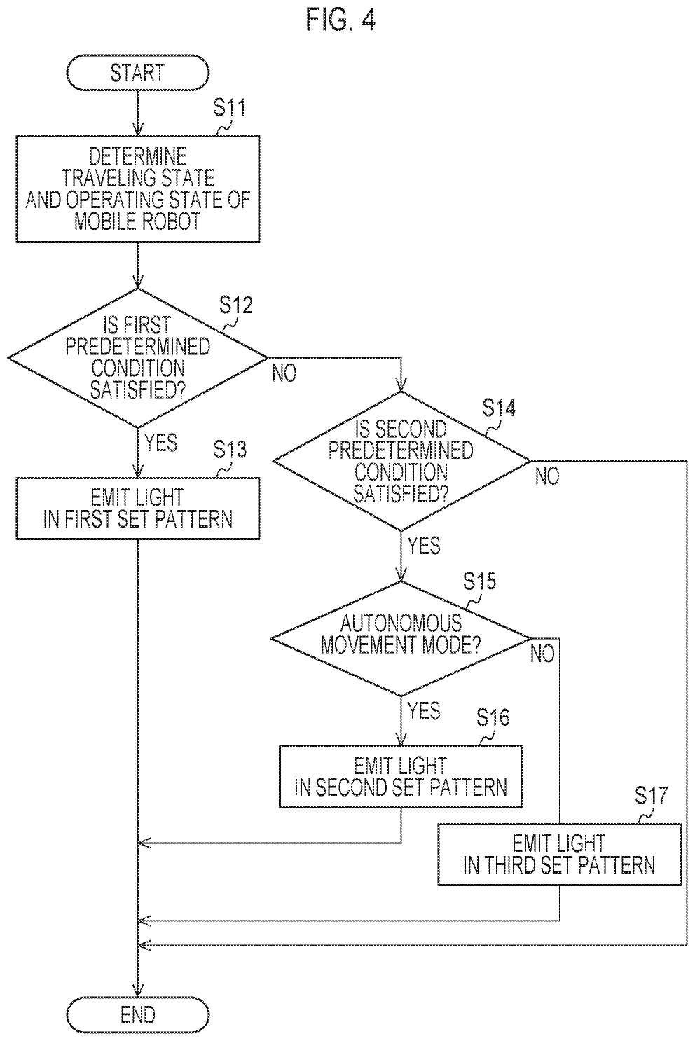

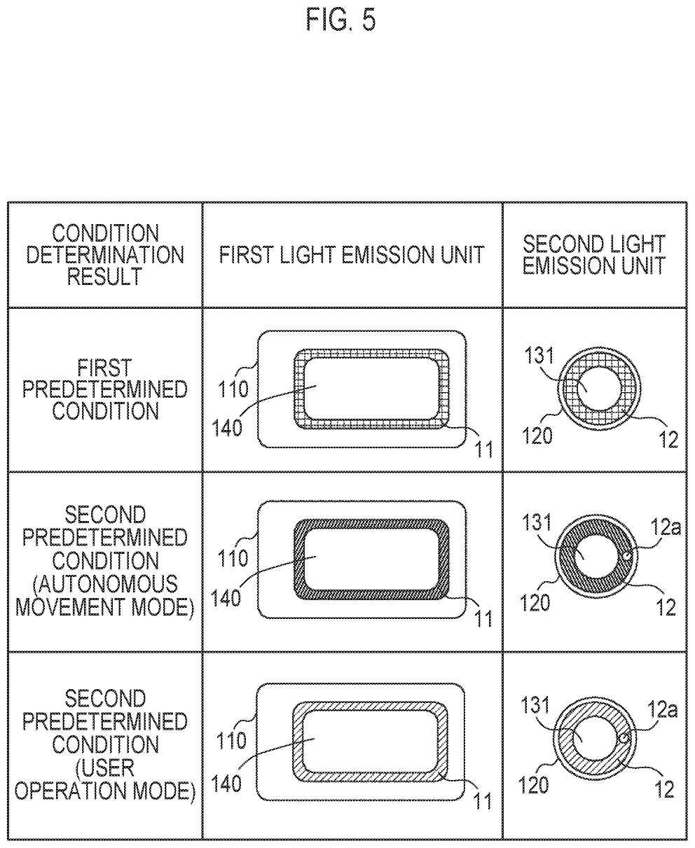

Next, an example of a main feature of the present embodiment will be described with reference to FIGS. 4 and 5. FIG. 4 is a flowchart for describing an example of a light emission process executed by the mobile robot 100. In addition, FIG. 5 is a diagram illustrating an example of a light emission pattern that can be executed in the mobile robot 100.

As the main feature of the present embodiment, the mobile robot 100 is provided with the contact portion as illustrated by the upper surface of the raising/lowering mechanism 140, and moves based on the movement operation of the mobile robot 100 received by the operation interface, such as the joystick device. Hereinafter, first, as an example of the operation interface, the joystick device provided in the mobile robot 100 will be described as an example. In addition, the mobile robot 100 can be provided with an operation unit that executes an operation, such as the movement operation, on the mobile robot 100 as illustrated by the operation unit 130, in addition to the operation interface, such as the joystick device. In addition, the transport system according to the present embodiment is provided with the light emission unit including the first light emission unit 11 disposed in the surrounding of the contact portion and the second light emission unit 12 disposed on the joystick device or in the surrounding of the joystick device.

Then, the control computer 101 executes light emission control of causing the light emission unit to emit light in different light emission patterns associated with each of a plurality of predetermined conditions, as a part of the system control. The light emission pattern can also be referred to as a light emission form. The light emission control includes control of linking a first light emission pattern that is a light emission pattern in the first light emission unit 11 with a second light emission pattern that is a light emission pattern in the second light emission unit 12. In addition, a correspondence relationship between the predetermined conditions and the light emission patterns can be, for example, stored as a table or the like in an internal storage unit of the control computer 101 and referred to when needed.

Here, the description will be made with an example in which the mobile robot 100 is provided with the light emission units at the two locations, but the light emission units just need to be disposed at two locations at the positions as illustrated by the first light emission unit 11 and the second light emission unit 12, and may be disposed at three or more locations. In addition, the position at which the light emission unit is provided or the shape or the size of the light emission unit are not limited to the illustrated position, shape, or size. The first light emission unit 11 just needs to be disposed in the surrounding of the contact portion and the second light emission unit 12 just needs to be provided in the joystick device or in the surrounding of the joystick device. Note that, from terms of visibility from the surrounding, the three or more disposed light emission units may be disposed at a plurality of positions separated from each other as illustrated by the first light emission unit 11 and the second light emission unit 12.

By executing such light emission control, many types of information, such as various states of the mobile robot 100, can be expressed by different light emission patterns. Therefore, the mobile robot 100 enables the reception of the movement operation by the user using the joystick device, and enables for the user and the surrounding of the mobile robot 100 to visually recognize the needed information in an easy-to-understand manner. In particular, since the mobile robot 100 is the mobile robot that can autonomously move and transport the transport object, and is provided with the joystick device that receives the movement operation by the user, a type of information that needs to be visually recognized by the user or the surrounding of the mobile robot is increased. However, by executing the light emission control, the mobile robot 100 enables the user or the surrounding of the mobile robot 100 to visually recognize the needed information in an easy-to-understand manner, as compared with a configuration in which the light emission unit is solely provided. In addition, the joystick device is a device that enables intuitive execution of the movement operation, and is easy to operate for the user.

In addition, the predetermined conditions do not matter, but can include, for example, at least one of a condition related to a traveling state related to a traveling environment of the mobile robot 100 and a condition related to an operating state of the mobile robot 100. The traveling state can indicate, for example, whether or not a traveling abnormality related to a traveling environment, such as contact with a wall, of the mobile robot 100 is occurring. For convenience, the description will be made in which the operating state indicates a state other than the mode state related to whether the mobile robot 100 is in the autonomous movement mode or the user operation mode. The description will be made in which the operating state indicates whether or not some operating abnormalities are occurring or indicates a content of the operating abnormality. The operating abnormality is an abnormality excluding an abnormality in the traveling state related to the traveling environment of the mobile robot 100, and can indicate various abnormalities of the mobile robot 100, such as a dead battery, an abnormality in the driving unit, and an abnormality in the wheels. In addition, the mobile robot 100 can also be configured to sense the occurrence of an earthquake or a fire, or the like, by communication from the outside or by a sensor provided in the mobile robot 100. With such a configuration, the predetermined conditions can also include the presence or absence of the occurrence of the earthquake or the presence or absence of the occurrence of the fire.

In addition, at least one of the predetermined conditions can be a predetermined condition for recommending the user operation on the mobile robot 100. Hereinafter, such a predetermined condition will be referred to as a recommendation condition. The recommendation condition indicates a condition in which there is a need to prompt the user operation, such as the movement operation by the user. The recommendation condition can indicate, for example, a condition in which the mobile robot 100 is in an unmovable state due to a traveling abnormality, such as collision with a wall or the like, although there is no operating abnormality. The movement operation here can be received from, for example, any one or both of the operation unit 130 and the joystick device, but the movement operation can also be received from, for example, an operation unit that is not provided in the mobile robot 100.

By executing the light emission control based on such condition settings, in the situation where the execution of the user operation, such as the movement operation by the user, on the mobile robot 100 is desirable, the mobile robot 100 enables a person in the surrounding of the mobile robot 100 to visually recognize notification for recommending the user operation. Therefore, in the mobile robot 100, the fact that the user operation is desirable can be noticed by the user, and the operation can be recommended to the user. The user can immediately determine a situation where the user operation is desirable and quickly execute the user operation.

In particular, by executing the light emission control of the light emission unit close to the operation unit, such as the second light emission unit 12, in, for example, a conspicuous color or a conspicuous light emission pattern, such as blinking in which a light emission portion continuously rotates, the effect of prompting the user operation is enhanced.

In this way, the light emission pattern associated with the recommendation condition can be a light emission pattern in which light is emitted in at least the second light emission unit 12. Therefore, since the notification for recommending the user operation can be indicated at a position that is easily viewed from an operation position or the surrounding of the operation position, the user operation can be recommended to the user more reliably.

In addition, the adopted predetermined conditions can also include a plurality of recommendation conditions in which the recommendation operation contents are different from each other, and as a result, the recommendation contents can be presented to the surrounding with a difference in the light emission patterns, that is, the recommendation content can be visually recognized by the user.

In addition, the recommendation condition can also include a condition for recommending the switching operation of switching from the autonomous movement mode to the user operation mode, that is, a condition for recommending the user operation of enabling the reception of the movement operation on the mobile robot 100. This condition can be, for example, a condition in which there are many people in the surrounding and the traveling state is determined to be put into a state that should be dealt with in a case where the traveling is executed in the autonomous movement mode. Therefore, the mobile robot 100 enables the person in the surrounding of the mobile robot 100 to visually recognize the notification for recommending the switching to the user operation mode, that is, the notification for prompting the user operation itself, and as a result, the user can be recommended to enable the reception of the movement operation.

For such switching, the control computer 101 can execute mode switching control of switching between the autonomous movement mode and the user operation mode as a part of the system control. Here, in a case where the movement operation is received from the operation unit 130, a user interface that receives the operation by using software can be displayed on a screen. In addition, the description is made with an example in which the joystick device and the operation unit 130 are provided as the operation unit provided in the mobile robot 100, but the operation unit just needs to be a device that receives the movement operation of causing the mobile robot 100 to move in the user operation mode. Note that, since the switching operation of switching between the autonomous movement mode and the user operation mode can also be received in any one of the joystick device and the operation unit 130, such a switching operation can be executed at hand of the mobile robot 100.

In addition, related to such switching, the control computer 101 can also execute, as at least a part of the light emission control, control of emitting light in different light emission patterns in accordance with whether the mode is the autonomous movement mode or the user operation mode for at least one predetermined condition among the above-described plurality of predetermined conditions.

In addition, the recommendation condition can also include a condition for recommending the movement operation of causing the mobile robot 100 to move in a predetermined direction. This condition can be, for example, a condition in which there are many people in the surrounding of the mobile robot 100 and there is a need to bypass. With the light emission control in accordance with such a recommendation condition, the user can be recommended to execute the movement operation in the predetermined direction. A bypass route may be indicated as the predetermined direction, and is particularly useful in the user operation mode.

In particular, in a case where the recommendation condition for recommending the movement operation of causing the mobile robot 100 to move in the predetermined direction is satisfied, the control computer 101 may control the first light emission unit 11 and the second light emission unit 12 to emit light such that the predetermined direction is indicated. For example, a light emission position may be changed in accordance with the predetermined direction. In this case, by controlling the light emission unit in the vicinity of the operation unit, such as the second light emission unit 12 in the surrounding of the joystick device, to indicate the predetermined direction, an operator can easily recognize the predetermined direction, and the movement operation in the predetermined direction can be recommended to the user in an easy-to-understand manner. The movement operation can also include a direction operation of causing the mobile robot 100 to move in a desired direction.

In the example where the light emission position is changed in accordance with the recommended movement direction in this way, particularly, the predetermined direction is indicated by the second light emission unit 12 that is the light emission unit in the surrounding of the joystick device, so that the user easily recognizes the direction in which the movement is recommended. In this example, since light is emitted to indicate an actual recommended movement direction, that is, a recommended azimuth, the light emission position is changed also in accordance with a current orientation of the mobile robot 100, that is, a current azimuth.

In addition, an example in which the second light emission unit 12 is provided in the surrounding of the stick portion 131 is described, but the present disclosure is not limited to this example. As long as the second light emission unit 12 is provided in the joystick device, for example, at a distal end of the stick portion 131, an operation location can be immediately visually recognized, and thus the user can quickly execute the user operation. In addition, even in a case of the light emission control of indicating the predetermined direction, by disposing the second light emission unit 12 in the joystick device or in the surrounding of the joystick device, the same effect can be obtained as long as the light emission control of indicating the predetermined direction can be executed on the light emission unit.

In addition, as described above, the light emission unit is provided with the first light emission unit 11 disposed at a position separated from the second light emission unit 12 provided in such a joystick device or the surrounding of the joystick device. Then, the light emission pattern associated with a condition other than the recommendation condition among the predetermined conditions can also be a light emission pattern in which light is emitted in at least the first light emission unit 11. Therefore, the user of the mobile robot 100 is enabled to visually recognize the notification other than the recommendation of the user operation in the joystick device at a position different from the operation position or the surrounding of the operation position, and then is enabled to easily determine that the notification is not the recommendation of the operation.

In addition, as illustrated in FIG. 1, the mobile robot 100 can be provided with the joystick device, receive the movement operation of causing the mobile robot 100 to move via the stick portion 131, and execute the notification for recommending the user operation via the second light emission unit 12. Therefore, the user operation can be received by using the joystick device that can intuitively execute the movement operation, and the notification can be visually recognized by the person in the surrounding of the joystick device. In addition, the surrounding person can include the operator (user) who executes the operation using the joystick device, and the user can easily understand the state of the mobile robot 100 at hand and can also easily execute the operation.

An example of the control described above will be described. The control computer 101 first determines the traveling state of the mobile robot 100 based on a detection result of the sensor 105 and the like, and determines the operating state indicating the presence or absence of the operating abnormality of the mobile robot 100 (step S11). An order of the determination of the traveling state and the operating state does not matter. Here, for the operating state, a determination is executed whether or not there is the operating abnormality, and whether an abnormal part is, for example, a battery, a driving unit, or wheels. The determination can be executed by the control computer 101, for example, based on the detection results of various sensors provided in the mobile robot 100.

Here, the determination of the traveling state can be executed by the control computer 101 executing information processing, image processing, or the like based on the detection results of the sensors, such as the sensor 105, and the description will be made on the premise that the determination is executed in such a manner. Note that the sensor can also have a function of determining the traveling state by executing detection such that the detection result indicates a determination result of the traveling state itself or by executing information processing, image processing, or the like based on the sensing result. In such a case, the sensor transmits the determination result to the control computer 101, and the control computer 101 can use the content received from the sensor as the determination result of the traveling state. The determination of the traveling state can also be executed by a determination unit provided separately from the control computer 101 that executes the light emission control.

As in the determination of the traveling state, the determination of the operating state can also be executed by the control computer 101 executing information processing, image processing, or the like based on the detection results of the various sensors, and the description will be made on the premise that the determination is executed in such a manner. Note that the sensor can also have a function of determining the operating state by executing detection such that the detection result indicates a determination result of the operating state itself or by executing information processing, image processing, or the like based on the sensing result. In such a case, the sensor transmits the determination result of the operating state to the control computer 101, and the control computer 101 can use the content received from the sensor as the determination result of the operating state. The determination of the operating state can also be executed by a determination unit provided separately from the control computer 101 that executes the light emission control.

In addition, the mobile robot 100 can be provided with a storage unit (not illustrated) that stores information indicating the traveling state and the operating state acquired in this way, for example, in the control computer 101. The control computer 101 can also determine the traveling state and the operating state based on the most recently stored information indicating the traveling state and the operating state, respectively.

After step S11, the control computer 101 determines whether or not a first predetermined condition is satisfied based on the determined traveling state and operating state (step S12). For convenience, the description will be made on the premise that the first predetermined condition is a condition that the traveling state and the operating state are normal without the abnormality.

Then, in a case of normality, the control computer 101 controls the first light emission unit 11 and the second light emission unit 12 to emit light, for example, in a first set pattern as illustrated by “first predetermined condition” of FIG. 5 (step S13), and finishes the process. Here, the first set pattern indicates a certain light emission pattern constituted of a set of the first light emission pattern in the first light emission unit 11 and the second light emission pattern in the second light emission unit 12. The first set pattern can be a light emission pattern in which the first light emission pattern in the first light emission unit 11 and the second light emission pattern in the second light emission unit 12 are linked.

On the other hand, in a case of abnormality, that is, in a case where there are some abnormalities in the traveling state and the operating state, the control computer 101 determines whether or not a second predetermined condition is satisfied (step S14). Here, the second predetermined condition can include the recommendation condition. For convenience, the description will be made on the premise that the second predetermined condition is a condition in which any one or both of the traveling state and the operating state is put into a state that should be dealt with in a case where the traveling is continued, and a predetermined user operation is recommended. In a case where the second predetermined condition is satisfied, the control computer 101 determines whether the autonomous movement mode or the user operation mode is in progress (step S15). Information indicating whether the mode is the autonomous movement mode or the user operation mode can be obtained with reference to a current movement mode of the control computer 101.

In a case of the autonomous movement mode, the control computer 101 controls the first light emission unit 11 and the second light emission unit 12 to emit light, for example, in a second set pattern as illustrated by “second predetermined condition (autonomous movement mode)” of FIG. 5 (step S16), and finishes the process. Here, the second set pattern indicates a certain light emission pattern constituted of a set of the first light emission pattern in the first light emission unit 11 and the second light emission pattern in the second light emission unit 12, and is a light emission pattern different from the first set pattern. The second set pattern can be a light emission pattern in which the first light emission pattern in the first light emission unit 11 and the second light emission pattern in the second light emission unit 12 are linked. The second set pattern includes a light emission pattern for recommending the switching to the user operation mode, and can also include a light emission pattern for recommending the movement operation in the predetermined direction, as illustrated by a blinking area 12a. Of course, an example such as the blinking area 12a indicating the predetermined direction can be similarly applied to the first light emission unit 11.

On the other hand, in a case of the user operation mode, the control computer 101 controls the first light emission unit 11 and the second light emission unit 12 to emit light, for example, in a third set pattern as illustrated by “second predetermined condition (user operation mode)” of FIG. 5 (step S17), and finishes the process. Here, the third set pattern indicates a certain light emission pattern constituted of a set of the first light emission pattern in the first light emission unit 11 and the second light emission pattern in the second light emission unit 12, and is a light emission pattern different from the first set pattern or the second set pattern. The third set pattern can be a light emission pattern in which the first light emission pattern in the first light emission unit 11 and the second light emission pattern in the second light emission unit 12 are linked. The third set pattern includes a light emission pattern for recommending the movement operation in the predetermined direction, as illustrated by the blinking area 12a. Of course, an example such as the blinking area 12a indicating the predetermined direction can be similarly applied to the first light emission unit 11.

Such a process can be repeated, for example, at predetermined determination intervals of the traveling state or the operating state, or each time there is a change in the detection result of the sensor used for determining the traveling state or the operating state.

In addition, as described above, the light emission control just needs to include control of linking the first light emission pattern with the second light emission pattern. Therefore, in the above-described example, all of the first to third set patterns are the light emission patterns in which the first light emission pattern in the first light emission unit 11 and the second light emission pattern in the second light emission unit 12 are linked, but the first light emission pattern in the first light emission unit 11 and the second light emission pattern in the second light emission unit 12 just needs to be linked in at least one set pattern.

In addition, in the first to third set patterns in this example, for example, the first set pattern can be a light emission pattern which is most inconspicuous, the second set pattern can be a light emission pattern which is most likely to be noticed by the surrounding person, and the third set pattern can be a light emission pattern which is most likely to be noticed by the operator. In addition, the light emission pattern in the light emission control can also include a pattern of turning off the light, for example, such that the first set pattern is a pattern in which the first light emission unit 11 and the second light emission unit 12 are turned off. As described above, the adopted light emission pattern, such as the first to third set patterns or another light emission pattern described below, can be, for example, stored as a table or the like in the control computer 101 and referred to in the light emission control.

Here, in the first set pattern, the same light emission pattern is used in the autonomous movement mode and the user operation mode, but even in a case of YES in step S12, the light emission patterns may be differentiated in accordance with the modes. In addition, here, although the example in which the process is executed by using solely the two predetermined conditions, the first predetermined condition and the second predetermined condition, is described, the conditions can be further subdivided by using three or more predetermined conditions to present different light emission patterns in accordance with each predetermined condition.

Then, in a case where any one of the traveling state and the operating state indicates the abnormality, the mobile robot 100 is often stopped, that is, on the standby. Therefore, the mobile robot 100 enables the surrounding person to easily determine in which mode the mobile robot 100 is stopped, by executing the light emission control in accordance with the autonomous movement mode and the user operation mode. That is, in a case where the mobile robot 100 is on the standby, the mobile robot 100 enables the person in the surrounding of the mobile robot 100 to visually recognize and easily determine whether the mobile robot 100 is on the standby in the autonomous movement mode or the user operation mode. The surrounding can include, in addition to the person existing in the surrounding, a monitoring camera described below as an environment camera, and the traveling state can be imaged even by the monitoring camera in an easy-to-understand manner. As can be seen from the above description, the first light emission unit 11 and the second light emission unit 12 can function as indicators indicating whether the autonomous movement mode or the user operation mode is in progress.

In addition, as described above, the first light emission unit 11 is a light emission unit disposed in the surrounding of the contact portion that can come into contact with the transport object in a case where the transport object is mounted and transported. That is, in the mobile robot 100, the light emission unit is disposed in consideration of a mounting location of the transport object, as illustrated by a positional relationship between the first light emission unit 11 and the raising/lowering stage. The contact portion can also be referred to as a mounting surface. In addition, the first light emission unit 11 is provided in a main body of the mobile robot 100 in the surrounding of the contact portion. The contact portion is a portion that comes into contact with the transport object in a case where the transport object is mounted and transported, and for example, a portion that comes into contact with the transport object solely before transport and in the middle of mounting the transport object can be excluded. In addition, the contact portion can be, for example, a contact portion that comes into contact with the bottom surface of the transport object, and thus a portion that comes into contact with a side surface of the transport object can be excluded. Of course, as the transport object, various transport objects can be assumed depending on the size or the shape of the transport object, but the contact portion that can come into contact with the transport object can indicate a portion, such as the upper surface of the raising/lowering mechanism 140, having the possibility of coming into contact with the transport object during transport the mounting object. Therefore, in a state where the wagon 500 or another transport object is mounted and transported, for example, light emitted from the first light emission unit 11 can be visually recognized from at least a diagonal upper side or a lateral direction of the mobile robot 100. Therefore, the mobile robot 100 is easily viewed from the surrounding even in a case where the transport object is mounted and is further easily viewed in a case where the transport object is not mounted, so that the surrounding of the mobile robot 100 can be notified which of predetermined conditions is satisfied, whether the autonomous movement mode or the user operation mode is in progress, or the like, in an easy-to-understand manner. In addition, in a case where the surrounding of the contact portion is caused to emit light as in this example and the wagon 500 is used for transport, the surrounding of the mobile robot 100 is enabled to more visually recognize the light emission by forming a lower surface of the wagon 500 as a mirror surface.

In addition, as described above, the second light emission unit 12 is a light emission unit provided in the joystick device that operates the mobile robot 100 or at the surrounding of the joystick device. In the mobile robot 100, the light emission unit is disposed at a high position, which corresponds to the operation position, that is easily viewed from the operator or the surrounding, as illustrated particularly by the second light emission unit 12. Therefore, the mobile robot 100 can notify the surroundings which of predetermined conditions is satisfied, whether the autonomous movement mode or the user operation mode is in progress, or the like, in an easy-to-understand manner, even from a direction in which the mounting position is difficult to be viewed depending on the transport object, such as the wagon 500.

In addition, as described above, the mobile robot 100 can be provided with the sensor 105 that senses the contact of the object with the outer periphery of the mobile robot 100. The determination of the traveling state in this case is executed as follows. That is, the control computer 101 determines that the traveling state has the traveling abnormality in a case where the sensor 105 senses that the object is in contact with the mobile robot 100, and determines that the traveling state does not have the traveling abnormality in a case where the sensor 105 does not sense that the object is in contact with the mobile robot 100. Then, in a case where a condition in which such contact occurs is added in at least one of the predetermined conditions, a case where the contact occurs can be presented with a light emission pattern different from other light emission patterns.

With such a configuration, the mobile robot 100 can notify the surroundings of the contact with the object in an easy-to-understand manner, and can notify the surroundings of the release of the contact in an easy-to-understand manner. In addition, the mobile robot 100 is provided with the sensor, such as the sensor 105, that senses the contact of the object with the bumper provided on the outer periphery of the mobile robot 100, so that the main body of the mobile robot 100 and the contacting object can be protected by the bumper. In addition, the determination of the abnormal state can also be executed based on, for example, information from other sensors, such as the camera 104 mounted on the mobile robot 100, without limitation to the sensor 105.

In addition, control of differentiating the light emission patterns, such as the first set pattern and the second set pattern, can include control of differentiating at least one of luminance, hue, chroma saturation, and brightness of the light emission in the light emission units illustrated by the first light emission unit 11 and the second light emission unit 12. That is, the different light emission patterns may include a light emission pattern in which at least one of the luminance, hue, chroma saturation, and brightness of the light emission in the light emission unit is differentiated. Therefore, the user can be notified of a larger amount of information in a distinguishable state, in an easy-to-understand manner.

In addition, in the first light emission unit 11 and the second light emission unit 12, the light emission units are disposed at a plurality of positions separated from each other. Therefore, the control of differentiating the set patterns or the light emission patterns of individual light emission units can include control of differentiating light emission parameters between the first light emission unit 11 and the second light emission unit 12 to emit light. Here, the light emission parameter can be at least one of the luminance, hue, chroma saturation, and brightness. Note that, in the present embodiment, a set pattern in which the first light emission pattern and the second light emission pattern are linked is used in a certain situation.

In addition, the control of differentiating the set patterns or the light emission patterns of individual light emission units can include differentiating positions at which light is emitted. Light can also be emitted at all the positions in a certain set pattern or a certain light emission pattern of individual light emission unit, and light is turned off at all the positions in another set pattern or another light emission pattern of individual light emission unit. For example, the control of differentiating the set patterns can include control of turning off one of the first light emission unit 11 and the second light emission unit 12 and causing solely the other to emit light, that is, control of turning on and off light emission.

In addition, differentiating the set pattern can also include differentiating a plurality of positions at which light is emitted synchronously with each other. With such a configuration, the mobile robot 100 can notify the surrounding of the mobile robot 100 of the content for which the notification is given in a further easy-to-understand manner.

Examples of such a set pattern will be described. In a certain light emission pattern, solely the first light emission unit 11 is caused to emit light, in another set pattern, solely the second light emission unit 12 is caused to emit light, and in still another set pattern, the first light emission unit 11 and the second light emission unit 12 are caused to emit light synchronously with each other. Examples of causing both the first light emission unit 11 and the second light emission unit 12 to emit light synchronously with each other include the example of “first predetermined condition” or the example of “second predetermined condition (user operation mode)” of FIG. 5. In an example in which the mobile robot 100 includes light emission units at three or more locations, a light emission pattern can be selected from among a large number of light emission patterns obtained from various combinations of the three or more provided light emission units.

On the other hand, examples of causing both the first light emission unit 11 and the second light emission unit 12 to emit light asynchronously with each other include the example of “second predetermined condition (autonomous movement mode)” of FIG. 5. In the example of the “second predetermined condition (autonomous movement mode)” of FIG. 5, the first light emission unit 11 and the second light emission unit 12 are illustrated by diametrically opposite hatching, but this hatching is a drawing for convenience, and indicates that solely the phases are different from each other. Note that this example can also be grasped as an example in which a light turn-on timing of the first light emission unit 11 and a light turn-off timing of the second light emission unit 12 are synchronized in a case where the first light emission unit 11 and the second light emission unit 12 are caused to emit light alternately, that is, an example in which the timing is controlled by linking the first light emission pattern with the second light emission pattern. In this way, the control computer 101 can control the light emission of the first light emission unit 11 and the second light emission unit 12 such that light emission timings of the first light emission unit 11 and the second light emission unit 12 are switched, that is, the light emission of the first light emission unit 11 and the light emission of the second light emission unit 12 are switched, as a certain set pattern.

Without limitation to the switching between the light emission timings as described above, the control computer 101 can cause the first light emission unit 11 and the second light emission unit 12 to emit light in different phases, as a certain light emission pattern, and as a result, the light emission can be presented to the surroundings at various rhythms.

Further, at the positions at which light is emitted synchronously with each other, light can be emitted in light emission patterns having a mutual complementary relationship. The light emission pattern having the mutual complementary relationship can be a pattern in which the first light emission unit 11 and the second light emission unit 12 are caused to emit light in a color that is easily viewed, as a set, for example, a pattern in which a light emission color in the first light emission unit 11 and a light emission color in the second light emission unit 12 are colors having a mutual complementary color relationship.

That is, the light emission control can include, as the synchronization control, control of emitting light such that the first light emission pattern and the second light emission pattern are the light emission patterns having the mutual complementary relationship. For example, by using the colors having the mutual complementary color relationship in the first light emission pattern and the second light emission pattern, colors that are easily viewed can be expressed by a set of the first light emission pattern and the second light emission pattern. In addition, control can also be executed such that light is emitted at a rhythm in which the light emission timings are switched between the first light emission pattern and the second light emission pattern. Therefore, the light emission that is likely to be noticed by the user can be executed in a case of the synchronization control.

In addition, the light emission control can include first asynchronization control and second asynchronization control as asynchronization control, in addition to the synchronization control. The synchronization control is control of emitting light in the first light emission pattern and the second light emission pattern that are associated with a first condition among the predetermined conditions synchronously with each other.

The first asynchronization control is a control of emitting light in the first light emission pattern associated with a second condition among the predetermined conditions asynchronously with the second light emission pattern, that is, control of emitting light in the first light emission pattern and the second light emission pattern independently. The second asynchronization control is a control of emitting light in the second light emission pattern associated with a third condition among the predetermined conditions asynchronously with the first light emission pattern, that is, control of emitting light in the first light emission pattern and the second light emission pattern independently. In the first asynchronization control and the second asynchronization control, control can be executed such that the first light emission unit 11 and the second light emission unit 12 are, for example, turned on and off at different cycles.

Adopting such a control example enables switching between methods for transmission of the information by, for example, executing the asynchronization control and the synchronization control when the information is desired to be separately transmitted and when the information is not desired to be separately transmitted, respectively.

In addition, the light emission control may include control of switching between the synchronization control, the first asynchronization control, and the second asynchronization control in accordance with the predetermined conditions. Therefore, the synchronization control, the first asynchronization control, and the second asynchronization control can be automatically switched in accordance with the predetermined conditions. Of course, the light emission control can also be synchronization control for any one of the predetermined conditions or asynchronization control for any one of the predetermined conditions.

In addition, the system control may include control of changing the first condition, the second condition, and the third condition. Therefore, the conditions for executing the synchronization control, the first asynchronization control, and the second asynchronization control can be changed, for example, to correspond to the traveling environment of the mobile robot 100 or in accordance with the sensing result of the sensor. For example, the conditions for executing the synchronization control, the first asynchronization control, and the second asynchronization control can also be changed by the user, such as an administrator, by the user operation to correspond to the traveling environment of the mobile robot 100.

In addition, the system control may include control of changing the first light emission pattern and the second light emission pattern used in each of the synchronization control, the first asynchronization control, and the second asynchronization control. Therefore, the light emission patterns expressed by each of the synchronization control, the first asynchronization control, and the second asynchronization control can be automatically changed in accordance with the traveling environment of the mobile robot 100 or a sensing result of a sensor, or can be changed in accordance with a user operation.

In addition, the second light emission unit 12 can also be provided with a plurality of individual light emission units disposed to surround the stick portion 131 at positions having different distances from a center position of the stick portion 131 in a horizontal direction. That is, the second light emission unit 12 can be provided with individual light emission units disposed double or triple, for example, to surround the stick portion 131. Therefore, various light emission patterns can be presented solely by the second light emission unit 12. In particular, in a situation where the operation is prompted, the light emission portions can also be sequentially moved from an inner individual light emission unit to an outer individual light emission unit. The first light emission unit 11 can also be similarly provided with a plurality of individual light emission units.

By using the various light emission patterns, that is, the various set patterns, the mobile robot 100 can notify the user and the surrounding of the mobile robot 100 of various information, such as which of predetermined conditions is satisfied or whether the autonomous movement mode or the user operation mode is in progress, in a distinguishable state, in a further easy-to-understand manner. In addition, for example, the control computer 101 can also suppress the light emission to achieve power saving in a case where there is no abnormal state, or notify the surroundings of the occurrence of the traveling abnormality with conspicuous light emission in a case where there is the abnormal state.

In addition, the system control may include control for stopping the movement of the mobile robot 100 when determination is executed that the traveling state is the traveling abnormality. Therefore, since the movement of the mobile robot 100 can be stopped in a case where the traveling state is abnormal, the occurrence of a further worst situation can be prevented in advance.

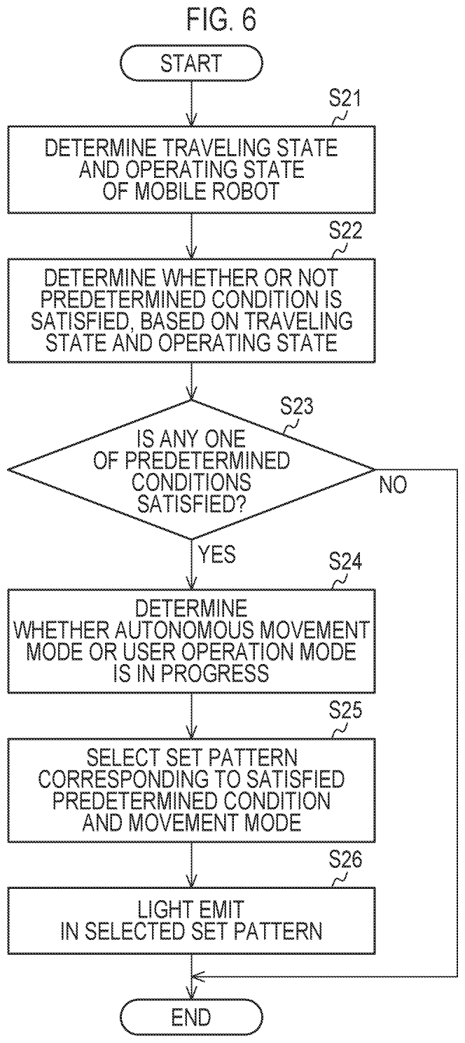

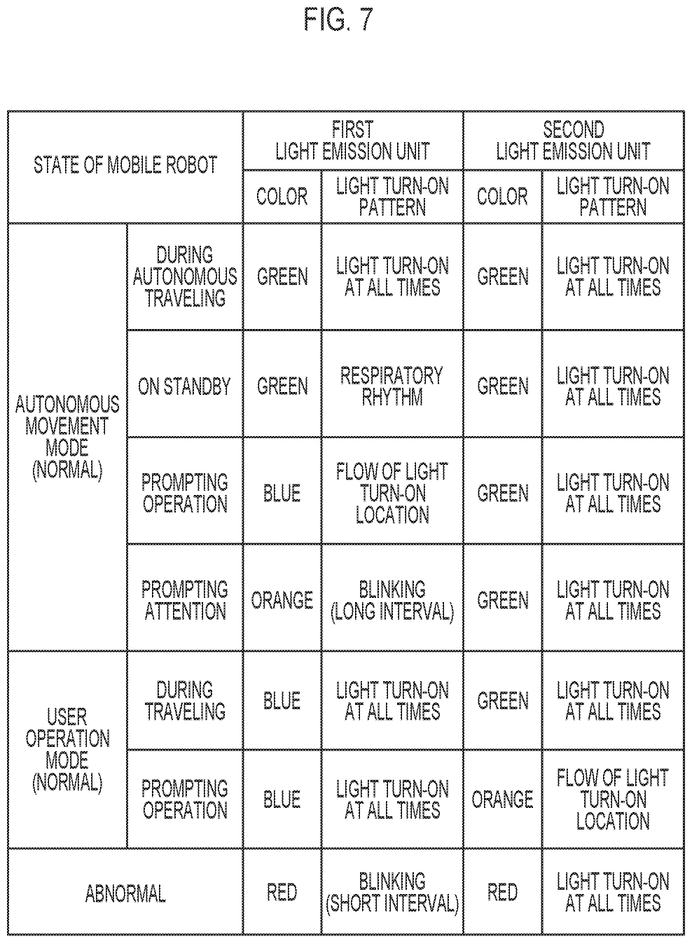

Next, another example of the light emission process that can be adopted in the present embodiment will be described with reference to FIGS. 6 and 7. FIG. 6 is a flowchart for describing another example of the light emission process executed by the mobile robot 100. FIG. 7 is a diagram illustrating another example of the light emission pattern that can be executed in the mobile robot 100.

The control computer 101 determines, as in step S11 of FIG. 4, the traveling state and the operating state of the mobile robot 100 (step S21). Next, the control computer 101 determines whether or not any one of the adopted predetermined conditions is satisfied, based on the determined traveling state and operating state (step S22), and in a case where the determination result indicates NO, that is, in a case of NO in step S23, finishes the process.

On the other hand, in a case of YES in step S23, the control computer 101 determines whether the current mode is the autonomous movement mode or the user operation mode (step S24). In step S24, information indicating whether the autonomous movement mode or the user operation mode in the operating state can be obtained with reference to the current movement mode of the control computer 101.

Next, the control computer 101 selects the set pattern corresponding to the satisfied predetermined condition and the current movement mode (step S25). Then, the control computer 101 controls the first light emission unit 11 and the second light emission unit 12 to emit light in the selected set pattern (step S26), and finishes the process. Such a process can be repeated, for example, each time there is the change in the detection result of the sensor used for determining the traveling state or the operating state, or at predetermined intervals.

In steps S25 and S26, the control computer 101 can execute the selection of the set pattern and the light emission control, for example, based on a correspondence relationship between the state and the light emission pattern illustrated in FIG. 7.

In addition, FIG. 7 illustrates a set pattern defined by the light emission color and a light turn-on pattern for each of the first light emission unit 11 and the second light emission unit 12, for each of a case of “autonomous movement mode and normal”, a case of “user operation mode and normal”, and a case where any one of the traveling state and the operating state is “abnormal”. Here, the term “normal” indicates that both the traveling state and the operating state are normal. In FIG. 7, as can be seen from the example of the set pattern, the second light emission unit 12 close to the operation unit 130 and the stick portion 131 mainly expresses the normal mode and the abnormality of the mobile robot 100, and the first light emission unit 11 expresses a detailed state of the mobile robot 100 in the autonomous movement mode.

As a detailed operating state in the autonomous movement mode, in FIG. 7, the case of “autonomous movement mode and normal” is classified into the following four cases and expressed. That is, FIG. 7 illustrates the light emission patterns to be classified into a case of “during autonomous traveling” indicating a state where the autonomous movement is in progress, a case of “on standby” indicating that the autonomous movement control is being executed but the mobile robot 100 is stopped and on the standby, a case of “prompting operation” indicating a situation where the user is prompted to execute some operations, and a case of “prompting attention” indicating a situation where the user or the surroundings are prompted to pay some attention. For example, the case of “during autonomous traveling” and the case of “on standby” of FIG. 7 are both a case where the first light emission unit 11 and the second light emission unit 12 are controlled to emit light in the same color, and is an example of the synchronization control. The case of “prompting operation” of FIG. 7 is a case where the first light emission unit 11 and the second light emission unit 12 are controlled to emit light in different colors and different light turn-on patterns, and is an example of the asynchronization control. The case of “prompting attention” of FIG. 7 is a case where the first light emission unit 11 and the second light emission unit 12 are controlled to emit light in different colors and different light turn-on patterns, and is another example of the asynchronization control.

The case of “on standby” in this example can indicate, for example, a case where the mobile robot 100 is being charged by a charger or a case where the mobile robot 100 is waiting for an elevator. The case of “prompting operation” can indicate, for example, a case where the mobile robot 100 has arrived at the transport destination. The case of “prompting attention” can indicate, for example, a case where the raising/lowering mechanism 140 is being raised and lowered or a case where the mobile robot 100 approaches an intersection. The case of “during autonomous traveling” indicates a case where another type of autonomous traveling is being executed.

In addition, as the light turn-on pattern of FIG. 7, an example also including a “respiratory rhythm” in which the light emission luminance is changed with a rhythm similar to a person's respiratory and “flow of light turn-on location” in which a light turn-on location is caused to flow is described. The example in which the light turn-on location is caused to flow means that, for example, the first light emission unit 11 is turned on such that the light turn-on location rotates around the raising/lowering mechanism 140 and the second light emission unit 12 is turned on such that the light turn-on location rotates around the stick portion 131.

The examples of the colors or the light turn-on patterns illustrated in FIG. 7 can, of course, be applied to the process examples described with reference to FIGS. 4 and 5.

As illustrated in the case of “prompting operation” of FIG. 7, in the light emission pattern associated with the recommendation condition, light can be emitted by at least the second light emission unit 12. With such a configuration, the notification for recommending the movement operation by the user can be indicated at a position that is easily viewed from the operation position or the surrounding of the operation position, and the notification can be visually recognized by the person, such as the operator, in the surrounding of the mobile robot. In addition, the light turn-on pattern illustrated in FIG. 7 can also include a light turn-on pattern indicating the predetermined direction in which the movement operation is prompted, as illustrated in FIG. 5, in a case where the movement operation is prompted.

In addition, although the example of FIG. 7 illustrates the example in which one light emission pattern is used in a case of the abnormality, even in a case of the abnormality, the light emission pattern can also be changed between the abnormality in the autonomous movement mode and the abnormality in the user operation mode.

In addition, although not illustrated in FIG. 7, the first light emission unit 11 may emit light in the light emission pattern associated with the condition other than the recommendation condition among the adopted predetermined conditions. With such a configuration, the surrounding person of the mobile robot 100 are enabled to visually recognize the notification other than the recommendation of the movement operation by the user at a position different from the operation position or the surrounding of the operation position, and then are enabled to easily determine that the notification is not the recommendation of the operation.

In the above description, as the configuration in which the transport system is provided with the light emission unit and the joystick device, the configuration in which the mobile robot 100 is provided with the joystick device that operates the mobile robot 100, the contact portion that comes into contact with the transport object in a case where the transport object is mounted and transported, the first light emission unit 11, and the second light emission unit 12 is described. In this configuration, since the joystick device is provided in the mobile robot 100, basically, the controller (illustrated by the control computer 101) provided in a portion of the mobile robot 100 other than the joystick device just needs to output control signals for the light emission control to the first light emission unit 11 and the second light emission unit 12. Note that a controller (not illustrated) provided in the joystick device may output the control signals for the light emission control to the first light emission unit 11 and the second light emission unit 12. In such a case, the determination of the predetermined condition for the light emission control may be executed by the control computer 101 and transmitted to the controller provided in the joystick device, or the controller provided in the joystick device may also execute the determination of the predetermined condition for the light emission control.

In the above description, the example in which the transport system is mainly configured with the mobile robot 100 is described, but the control system according to the present embodiment just needs to be a control system that executes the system control of controlling the transport system, as described above. Then, the transport system can also be provided with a server connectable to the mobile robot 100 through wireless communication. The server is a server that provides information for the autonomous movement to the mobile robot 100. The server can also be referred to as the host management device because the server manages the mobile robot 100, and can be constructed as a system in which functions are distributed to a plurality of devices, without limitation to the configuration by a single device.

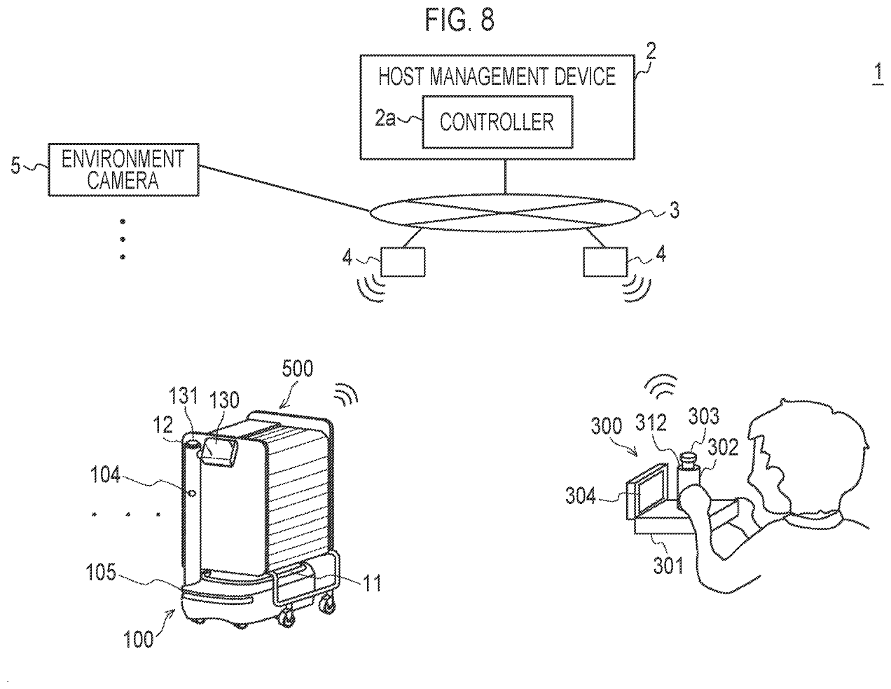

Hereinafter, an example in which this transport system is provided with the mobile robot 100 and the host management device will be described with reference to FIG. 8. FIG. 8 is a schematic diagram illustrating an overall configuration example of the transport system including the mobile robot 100.

As illustrated in FIG. 8, the transport system 1 is provided with a mobile robot 100, a host management device 2, a network 3, a communication unit 4, an environment camera 5, and a user terminal device 300. The transport system 1 is a system that transports a transport object via the mobile robot 100, and includes a control system in the present configuration example. In a case of this example, the control system can indicate the mobile robot 100 and the host management device 2, or can indicate components of control systems provided in the mobile robot 100 and the host management device 2. Alternatively, the control system can indicate, for example, the mobile robot 100, the host management device 2, and the user terminal device 300, or can indicate components of control systems provided in the mobile robot 100, the host management device 2, and the user terminal device 300.

The mobile robot 100 and the user terminal device 300 are connected to the host management device 2 through the communication unit 4 and the network 3. The network 3 is a wired or wireless local area network (LAN) or wide area network (WAN). Further, the host management device 2 and the environment camera 5 are connected to the network 3 through wired or wireless connection. As can be seen from such a configuration, all of the mobile robot 100, the host management device 2, and the environment camera 5 are provided with a communication unit. The communication unit 4 is, for example, a wireless LAN unit installed in each environment. The communication unit 4 may be, for example, a general-purpose communication device, such as a Wi-Fi (registered trademark) router.

The host management device 2 is a device connectable to the mobile robot 100 through wireless communication, is a management system that manages a plurality of the mobile robots 100, and can be provided with a controller 2a that executes control thereof. For example, the controller 2a can be realized by an integrated circuit, and can be realized by, for example, a processor, such as an MPU or a CPU, a work memory, and a non-transitory storage medium. A control program to be executed by the processor is stored in the non-transitory storage medium, and the processor can perform functions of the controller 2a by reading out the program into the work memory and executing the program. The controller 2a can be referred to as a control computer. The controller 2a may include a plurality of processors.

The transport system 1 can efficiently control the mobile robots 100 while causing the mobile robots 100 to autonomously move in a predetermined facility in an autonomous movement mode or causing the mobile robots 100 to move based on a user operation in a user operation mode. The facility can indicate various types of facilities, such as a medical care facility, such as a hospital, a rehabilitation center, a nursing care facility, or a residential facility for the elderly, a commercial facility, such as a hotel, a restaurant, an office building, an event venue, or a shopping mall, and other complex facilities.

In order to execute such efficient control, a plurality of the environment cameras 5 can be installed in the facility. The environment camera 5 acquires an image of a range in which the person or the mobile robot 100 moves, and outputs image data indicating the image. The image data may be still image data or moving image data, and in a case where the image data is the still image data, the still image data is obtained for each imaging interval. In addition, in the transport system 1, the host management device 2 collects the image acquired by the environment camera 5 or information based on the image. For an image used for controlling the mobile robot 100, an image acquired by the environment camera 5 or the like may be directly transmitted to the mobile robot 100, or may be transmitted to the user terminal device 300 through the host management device 2 or directly in the user operation mode. The environment camera 5 can be provided as a monitoring camera in the passage or the entrance in the facility.

The host management device 2 can decide the mobile robot 100 that executes a transport task for each transport request, to transmit an operation command for executing the transport task to the decided mobile robot 100. The mobile robot 100 can autonomously move from a transport source to arrive at a transport destination in accordance with the operation command. A method of deciding a transport route or the like in this case does not matter.

For example, the host management device 2 assigns the transport task to the mobile robot 100 at the transport source or in the vicinity of the transport source. Alternatively, the host management device 2 assigns the transport task to the mobile robot 100 moving toward the transport source or the vicinity of the transport source. The mobile robot 100 to which the task is assigned moves to the transport source to pick up the transport object.

The user terminal device 300 is a device that remotely operates the mobile robot 100 through the host management device 2 or directly in the user operation mode, can have a communication function for the remote operation, and can be provided with a display unit 304. In a case where the user terminal device 300 is a device that remotely operates the mobile robot 100 through the host management device 2, the user terminal device 300 corresponds to the remote operation device of the host management device 2. As the user terminal device 300, for example, various types of terminal devices, such as a tablet computer and a smartphone, can be applied. In addition, the user terminal device 300 can also receive the switching operation of switching between the user operation mode and the autonomous movement mode, and in a case where the switching operation is executed, the mode switching of the mobile robot 100 can be executed through the host management device 2.

Here, an example in which the user terminal device 300 is provided with the joystick device that functions as the remote operation device connectable to the mobile robot 100 through wireless communication will be described. The user terminal device 300 can be provided with a stick portion 302 and a button 303 as a part of a joystick device, in addition to a main body portion 301. The joystick device is a device that executes the movement operation of causing the mobile robot 100 to move in a direction intended by the user in the user operation mode. A direction operation can be received by tilting the stick portion 302 in a direction desired to move. The button 303 can be provided, for example, on the upper surface of the stick portion 302.

In addition, the joystick device can also control to execute the switching operation of switching between the autonomous movement mode and the user operation mode, by pressing the button 303 downward. Alternatively, the joystick device can also control to execute a decision operation, by pressing the button 303 downward. In addition, the button 303 can also be configured to play a role of an emergency stop button by being pressed downward for a predetermined period. In a case of the configuration in which a plurality of operations of the switching operation, the decision operation, and the emergency stop operation can be received by the button 303, that is, in a case where a plurality of operation contents is assigned to the button 303, a predetermined period corresponding to each operation just needs to be set.

In addition, in a case where the user terminal device 300 is provided with the joystick device, the user can execute the same operation as in the joystick device provided with the mobile robot 100. Further, in a case where the user terminal device 300 is provided with the joystick device, the light emission unit (hereinafter, referred to as a terminal-side second light emission unit 312), such as the second light emission unit 12, can also be disposed in the joystick device or in the surrounding of the joystick device to execute the light emission control as in the second light emission unit 12. FIG. 8 illustrates an example in which the terminal-side second light emission unit 312 is disposed on the upper surface of the stick portion 302 to have a light emission area in the surrounding of the button 303, but the present disclosure is not limited to this example, and the terminal-side second light emission unit 312 just needs to be disposed in the joystick device or the surrounding of the joystick device. In addition, a shape of the light emission area of the terminal-side second light emission unit 312 is not limited to the illustrated shape. For example, the terminal-side second light emission unit 312 can also indicate the light emission pattern as a display image by using the display unit 304. In addition, in a configuration in which the transport system 1 manages the plurality of mobile robots 100, in the user operation mode, the mobile robot 100 that is a remote operation target can be selected from the user terminal device 300.

In addition, the transport system 1 just needs to be provided with the light emission unit and the joystick device, and may have a configuration in which the second light emission unit 12 is not disposed in the mobile robot 100. For example, the first light emission unit 11 can be disposed in the surrounding of the contact portion in the mobile robot 100, and the terminal-side second light emission unit 312 as a substitute for the second light emission unit 12 can be disposed in the joystick device as the remote operation device of the mobile robot 100 or in the surrounding of the joystick device. Of course, as illustrated in FIG. 8, the joystick device can also be provided with both the mobile robot 100 and the user terminal device 300. In such a case, the second light emission unit just needs to be provided in the joystick device or in the surrounding of the joystick device of one of the mobile robot 100 and the user terminal device 300, but the second light emission units may be provided in the joystick devices or in the surroundings of the joystick devices of both of the mobile robot 100 and the user terminal device 300.

The display unit 304 can display an image indicated by image data received from a camera 104 in the mobile robot 100 and an image indicated by image data received from the environment camera 5 in the surrounding of the mobile robot 100. Therefore, the user can operate the mobile robot 100 by using the stick portion 302 and the button 303.

In addition, the user terminal device 300 can function as a device for making the transport request or the like with respect to the host management device 2. The transport request can also include information indicating the transport object.

In the transport system 1 having the above-described configuration, in any one of a case where the joystick device is provided in the mobile robot 100, a case where the joystick device is provided in the user terminal device 300, and a case where the joystick devices are provided in both the mobile robot 100 and the user terminal device 300, the host management device 2 may output the control signal for the light emission control. In a case where the host management device 2 outputs the control signal, the control signal can be output in the controller 2a. In such a case, the determination of the predetermined condition for the light emission control just needs to be executed by the controller 2a of the host management device 2, but the determination of the predetermined condition for the light emission control may be executed by the control computer 101 and transmitted to the host management device 2, or may be executed by the controller provided in the joystick device and transmitted to the host management device 2.

Alternatively, the transport system 1 can have a configuration in which the controller (not illustrated) provided in the joystick device outputs the control signal for the light emission control. Here, in a case where the joystick device is provided in one of the mobile robot 100 and the user terminal device 300, the controller of the joystick device can output the control signal, and in a case where the joystick devices are provided in both the mobile robot 100 and the user terminal device 300, the controller of any one of the joystick devices just needs to output the control signal or the controllers of both the joystick devices just need to output the control signals to the light emission units provided in the joystick devices or in the surroundings of the joystick devices. For example, in a case where the joystick device is provided in the user terminal device 300, the control computer 101 of the mobile robot 100 can also execute the light emission control in the first light emission unit 11 based on the control signal output by the controller provided in the joystick device for the light emission control.

Alternatively, the transport system 1 having the above-described configuration can also have a configuration in which the controller (illustrated by the control computer 101) provided in the mobile robot 100 outputs the control signal for the light emission control. In such a case, the determination of the predetermined condition for the light emission control just needs to be executed by the control computer 101, or the determination of the predetermined condition for the light emission control may be executed by the controller 2a of the host management device 2 or the controller provided in the joystick device and transmitted to the mobile robot 100. In addition, instead of the transport system 1, a transport system can also be configured not to be provided with the host management device 2. In such a configuration, the controller of the mobile robot 100 illustrated by the control computer 101 can determine the predetermined condition and output the control signal for the light emission control, or, for example, the controller provided in the joystick device can determine the predetermined condition and output the control signal for the light emission control.

Further, the control system in the transport system 1 can execute the following control, at least in a case where the host management device 2 cannot communicate with the mobile robot 100 or in a configuration in which the host management device 2 does not acquire the state of the mobile robot 100 through communication. That is, in a case where the communication is not possible or in a case where the configuration in which the host management device 2 does not acquire the state of the mobile robot 100 through the communication is adopted, the control system can determine, based on an image of the mobile robot 100 captured by the environment camera 5, the state or the movement mode of the mobile robot 100 from the light emission pattern indicated by the image. Here, the movement mode indicates whether the mobile robot 100 is in the autonomous movement mode or the user operation mode. The image can be an image captured by a camera of another mobile robot provided in the transport system 1, instead of the image captured by the environment camera 5 or in addition to the image captured by the environment camera 5. Although description of the terminal-side second light emission unit 312 is omitted here, the control system can also determine the state or the movement mode of the mobile robot 100 with reference to the light emission pattern in the terminal-side second light emission unit 312. In such a case, the control system also executes the determination with reference to the image of the user terminal device 300 captured by the camera, such as the environment camera 5.

The mobile robot 100, or the mobile robot 100 and the user terminal device 300 that operates the mobile robot 100 can present various light emission patterns in accordance with whether the predetermined condition is satisfied, as illustrated in FIG. 5 or 7, and the host management device 2 can determine the current movement mode or the current state of the mobile robot 100 from the currently presented light emission pattern. Although the example of FIG. 7 illustrates the example in which one light emission pattern is used in a case of the abnormality, even in a case of the abnormality, the host management device 2 can determine whether the autonomous movement mode or the user operation mode is in progress by changing the light emission pattern between the abnormality in the autonomous movement mode and the abnormality in the user operation mode.

With such a configuration, in the control system of the transport system 1, even in a case where the communication between the mobile robot 100 and the host management device 2 is not possible or in a case where the configuration in which the host management device 2 does not acquire the state of the mobile robot 100 through communication is adopted, the host management device 2 can determine whether or not the mobile robot 100 is in a state where the predetermined condition is satisfied, or the movement mode.

Therefore, for example, in a case where the mobile robot 100 that cannot communicate satisfies a certain predetermined condition and is in the autonomous movement mode, the host management device 2 can instruct a certain user to manually move, withdraw, or inspect the mobile robot 100. Then, the user can execute the work in accordance with the instruction. In addition, for example, in a case where the mobile robot 100 that cannot communicate satisfies a certain predetermined condition, such as on standby, and is in the user operation mode, the operator is away from the mobile robot 100 and the mobile robot 100 is in a left state. Therefore, in such a case, the host management device 2 can also give the notification to the operator such that the operator returns to the position of the mobile robot 100. The same effects can be obtained even in a configuration in which the host management device 2 does not acquire the state of the mobile robot 100 through communication.

Here, a method by which the mobile robot 100 determines the traveling abnormality will be described. Also in the transport system 1, the mobile robot 100 can determine the traveling abnormality by the same method as described with reference to FIG. 1 and the like.

As another determination method, the mobile robot 100 can also determine the traveling abnormality based on the image captured by the environment camera 5 and transmitted to the mobile robot 100 directly or through the host management device 2. Here, an image captured by a camera of another mobile robot instead of the environment camera 5 can also be used for the determination. That is, the control computer 101 can determine the traveling abnormality based on the image captured by the camera, such as the environment camera 5 or the camera of another mobile robot, installed in the facility in which the mobile robot 100 is practically used. In addition, the controller 2a of the host management device 2 can also execute such a determination, and in such a case, information indicating the traveling state may be transmitted in advance to the mobile robot 100 in preparation for the disconnection of wireless communication with the host management device 2.

Even in a configuration in which the mobile robot 100 acquires the information indicating the traveling state from the host management device 2, the mobile robot 100 can acquire the information before the communication with the host management device 2 is disconnected. Therefore, the mobile robot 100 can execute the light emission control in accordance with the information obtained before the communication is disconnected.

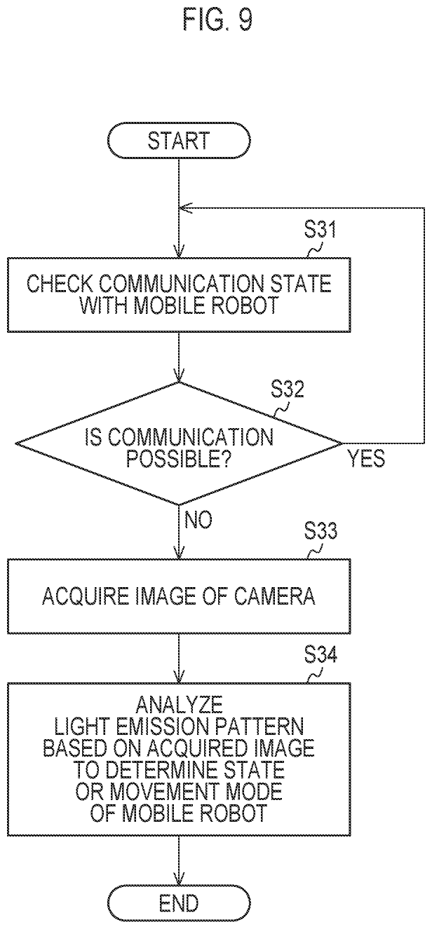

Next, a process example in the host management device 2 in the transport system 1 will be described with reference to FIG. 9. FIG. 9 is a flowchart for describing the process example in the host management device 2 in the transport system 1 of FIG. 8.

First, in the host management device 2, the controller 2a monitors a communication unit (not illustrated), checks the communication state with the mobile robot 100 (step S31), and determines whether or not the communication is possible (step S32). In a case where the controller 2a determines that the communication with the mobile robot 100 is possible, the controller 2a returns to step S31 and continues the monitoring. In a case where the controller 2a determines that the communication with the mobile robot 100 is not possible, the controller 2a acquires an image from the camera (step S33). The camera can be the environment camera 5, a camera provided in another mobile robot that travels in the vicinity of a place in which the communication with the mobile robot 100 is disconnected, or both the environment camera 5 and the camera provided in another mobile robot.

Next, the controller 2a analyzes the light emission pattern of the mobile robot 100 or the light emission pattern of at least one of the mobile robot 100 and the user terminal device 300 that operates the mobile robot 100, based on the acquired image, to determine the state or the movement mode of the mobile robot 100 (step S34), and finishes the process. Of course, in step S34, the determination of which of predetermined conditions is satisfied can also be included. In the analysis of the light emission pattern and the determination in the mobile robot 100, the controller 2a can also be configured to obtain the state or the movement mode of the mobile robot 100 based on the image by using the learning model obtained by the machine learning.

In this way, in the control system of the transport system 1, even in a case where the communication between the mobile robot 100 and the host management device 2 is not possible, the host management device 2 can determine whether or not the mobile robot 100 is in the autonomous movement mode or the user operation mode or which of predetermined conditions is satisfied, as presented with the light emission pattern by the mobile robot 100, or the mobile robot 100 and the user terminal device 300 that operates the mobile robot 100.

In addition, in a configuration in which the mobile robot 100 or the user terminal device 300 can express the operating state with the light emission pattern, that is, in a configuration in which the condition related to the operating state is included in the predetermined condition, the system control can include control of determining the operating state of the mobile robot 100 from the light emission pattern indicated by the image. Therefore, for example, in a case where the mobile robot 100 that cannot communicate has the operating abnormality, the user can be instructed to withdraw or inspect the mobile robot 100, and the user can execute the work in accordance with the instruction.

Even in a configuration in which the host management device 2 is not provided, the transport system can be provided with the environment camera 5 that can wirelessly communicate with the mobile robot 100, and even in such a configuration example, similarly, can also determine the state, the movement mode, or the like of the mobile robot 100 based on the image obtained from the environment camera 5. Of course, in a case where the mobile robot 100 can communicate with another mobile robot, the state, the movement mode, or the like of the mobile robot 100 can be determined based on the image acquired by the camera mounted on another mobile robot.

In addition, the transport system according to the present embodiment just needs to be configured to receive the movement operation by the user from the operation interface, without limitation to the joystick device, and even in such a case, similarly, enables the user of the operation interface or the surrounding of the mobile robot to visually recognize needed information in an easy-to-understand manner.

For example, the user terminal device 300 can also be provided with a joystick device, such as the stick portion 131, with which the movement operation is executed by moving a hand in a desired direction in a state where the upper portion of the stick portion 131 is wrapped with the palm of the hand, instead of providing the joystick device having the above-described shape.

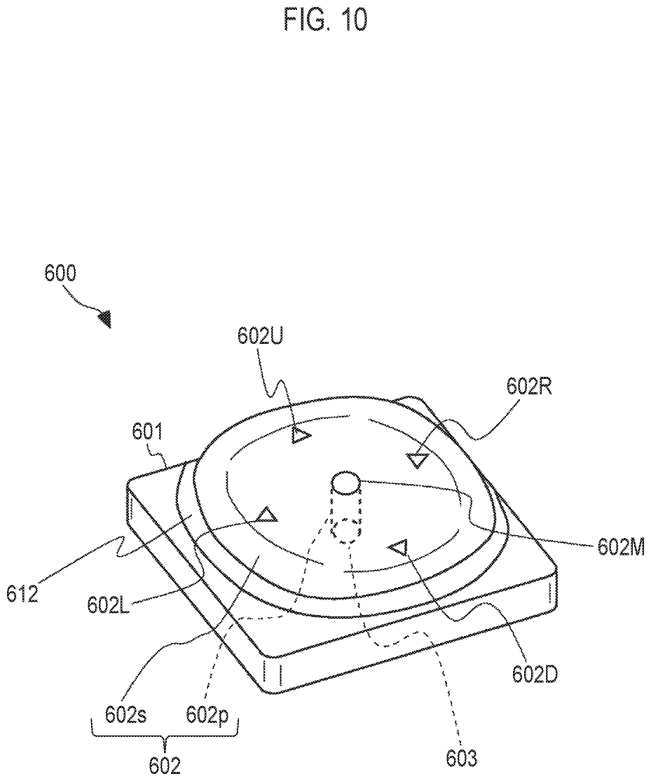

An example of such a joystick device will be described with reference to FIG. 10. FIG. 10 is a perspective view illustrating another example of the joystick device that operates the mobile robot 100. A joystick device 600 illustrated in FIG. 10 can be provided with a main body portion 601, a stick member 602, and a button 603, and can be provided in the user terminal device 300 instead of the joystick device provided as the stick portion 302 or the like in the user terminal device 300, or can be used as a substitute for the user terminal device 300.

The stick member 602 can be a member provided with a placement surface 602s on which a palm of a hand of a person is placed, on a stick portion 602p, and is assigned the movement operation. As illustrated in FIG. 10, on the placement surface 602s, arrows 602U, 602D, 602R, 602L indicating up (front), down (rear), right, and left operation directions of the stick portion 602p can also be written on the placement surface 602s, or a mark 602M indicating the existence or the meaning of the button 603 can also be shown. In addition, the button 603 can be a button provided on a lower side of the stick portion 602p in the main body portion 601 and configured to be pressed by the user pressing the placement surface 602s from above, and can be assigned a mode switching operation or the like.

Then, the joystick device 600 is provided with a second light emission unit 612 that can emit light in the light emission pattern linked with the light emission pattern in the first light emission unit 11, in the main body portion 601 located in the surrounding of the placement surface 602s. The second light emission unit 612 can also be provided at the outer peripheral end portion of the placement surface 602s, and a shape, a size, or a position of the second light emission unit 612 does not matter as in the second light emission unit 12 or the terminal-side second light emission unit 312. In addition, the joystick device 600 described here can also be provided as an example of a joystick device configured with the stick portion 131 or the like provided in the mobile robot 100.

Alternatively, the joystick device 600 illustrated in FIG. 10 can also be an operation device in which the stick portion 602p is not provided or the stick portion 602p is provided to be fixed to the main body portion 601, and a touch sensor is provided on a portion illustrated as the placement surface 602s. The operation device having such a configuration can receive the movement operation of the mobile robot 100 by the user executing finger sliding operation with the touch sensor. In addition, the operation device having such a configuration can also be provided instead of the joystick device configured with the stick portion 131 or the like provided in the mobile robot 100.

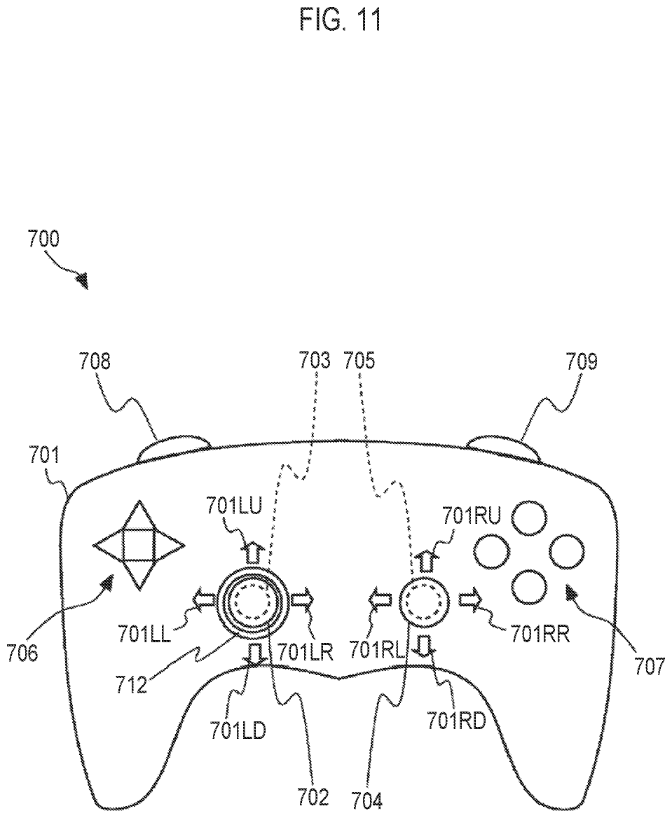

In addition, the user terminal device 300 can also be an operation device having a shape as illustrated in FIG. 11. FIG. 11 is a top view illustrating an example of an operation interface that operates the mobile robot 100. An operation device 700 illustrated in FIG. 11 is an example of the operation interface that receives the movement operation of the mobile robot 100. The operation device 700 can be provided with a main body portion 701, stick portions 702, 704, buttons 703, 705, a cross key 706, a selection button group 707, a left side button 708, and a right side button 709. In addition, as illustrated in FIG. 11, on the surface of the main body portion 701, arrows 701LU, 701LD, 701LR, 701LL and arrows 701RU, 701RD, 701RR, 701RL indicating up (front), down (rear), right, and left operation directions of the stick portions 702, 704, respectively, can also be shown. In addition, the buttons 703, 705 can be buttons provided, respectively, on lower sides of the stick portion 702, 704 in the main body portion 701 and configured to be pressed by the user pressing the stick portions 702, 704 from above.

In the operation device 700, for example, any one of the direction operation by the stick portion 702, the direction operation by the stick portion 704, the cross key 706, and the selection button group 707 can be assigned to the movement operation. In addition, in the operation device 700, a member different from the member assigned to the movement operation can be assigned to the mode switching operation or the like. For example, in the operation device 700, one member of the button 703, the button 705, one key of the cross key 706, one button of the selection button group 707, the left side button 708, and the right side button 709 can be assigned to the mode switching operation.

Then, the operation device 700 is provided with a second light emission unit 712 that can emit light in the light emission pattern linked with the light emission pattern in the first light emission unit 11, in the main body portion 701 located in the surrounding of the stick portion 702. Further, a second light emission unit similar to the second light emission unit 712 can also be provided in the surrounding of the stick portion 704 instead of the surrounding of the stick portion 702 or in addition to the surrounding of the stick portion 702. In addition, the second light emission unit 712 can also be provided at the outer peripheral end portion of the stick portion 702, and a shape, a size, or a position of the second light emission unit 712 does not matter as in the second light emission unit 12 or the terminal-side second light emission unit 312.

In addition, although the description is made on the premise that the operation device 700 is provided as a substitute for the user terminal device 300, the operation device 700 can also be provided in the mobile robot 100 instead of the joystick device configured with the stick portion 131 or the like provided in the mobile robot 100. In such a case, the operation device 700 may be mounted on the mobile robot 100 in a fixed state or may be detachably attached to the mobile robot 100.

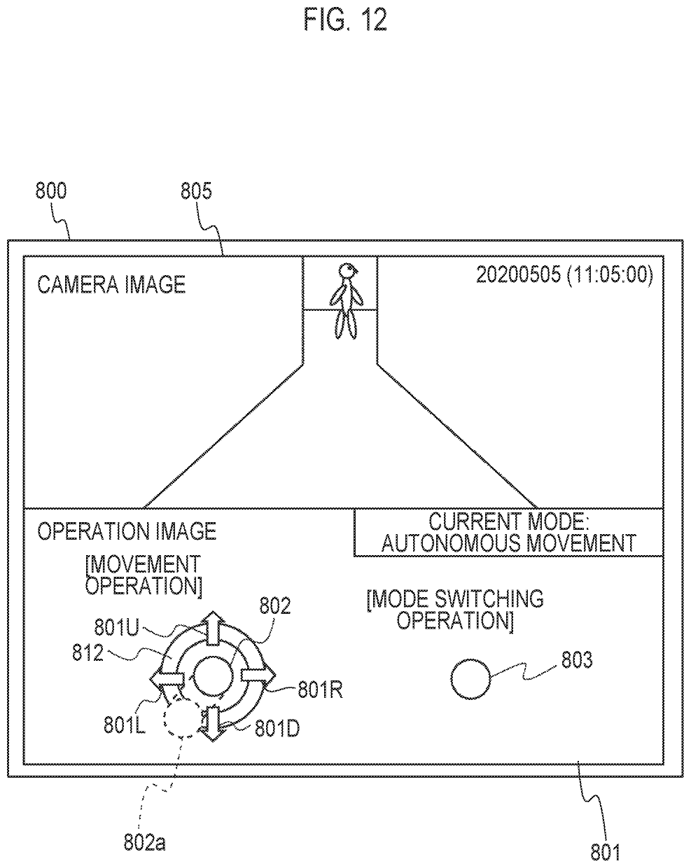

In addition, instead of the user terminal device 300, an operation interface that receives the operation by using software, as illustrated in FIG. 12, can also be used. FIG. 12 is a top view illustrating another example of the operation interface that operates the mobile robot 100. The operation interface that receives the operation by using software can be an operation device provided with a display device and a graphical user interface image displayed on the display device such that an image of an operation target can be selected or moved. For example, the graphical user interface image can include an image such as an icon for the movement operation, and can also include an image such as an icon for the switching operation.

The operation device 800 illustrated in FIG. 12 is the graphical user interface image displayed on the display device, and the image can include an operation image 801 and a camera image 805. Of course, a configuration in which the camera image 805 is not displayed in a case where the remote operation is not taken into consideration can also be adopted. The operation image 801 can include a stick member image 802 for the movement operation and a button image 803 for the mode switching operation.

The button image 803 is an image of a button that receives the switching operation, and the operation image 801 can also include information indicating the current mode. In addition, the stick member image 802 can be moved up, down, right, or left in a state of being touched, and in such a case, as illustrated in FIG. 12, the stick member image 802a at the movement destination can also be displayed together with an image connecting the stick member image 802a and the original stick member image 802 in a state where the original stick member image 802 is left as it is. In addition, on the operation image 801, images 801U, 801D, 801R, 801L of arrows indicating up (front), down (rear), right, and left operation directions for the stick member image 802 can also be shown. Instead of the stick member image 802, the images 801U, 801D, 801R, 801L can also be buttons that receive the movement operations in the up, down, right, and left operation directions, respectively.

Then, the operation device 800 is provided with a second light emission unit 812 that can emit light in the light emission pattern linked with the light emission pattern in the first light emission unit 11, at a position in the surrounding of the stick member image 802. In this example, by displaying the second light emission unit 812 as an image, light is emitted in this display area, that is, this display area is displayed by an image of the light emission pattern linked with the light emission pattern in the first light emission unit 11. The second light emission unit 812 can also be referred to as a light emission image. In addition, the second light emission unit 812 can also be provided at the outer peripheral end portion of the stick member image 802 such that the light emission area is changed in accordance with the movement operation of the stick member image 802, and a shape, a size, or a position of the second light emission unit 812 does not matter as in the second light emission unit 12 or the terminal-side second light emission unit 312.

In addition, although the description is made on the premise that the operation device 800 is provided as a substitute for the user terminal device 300, the operation device 800 can also be provided in the mobile robot 100 instead of the joystick device configured with the stick portion 131 or the like provided in the mobile robot 100. In such a case, as described above, the operation device 800 is provided as the operation unit 130. The operation unit 130 may be mounted on the mobile robot 100 in a fixed state or may be detachably attached to the mobile robot 100.

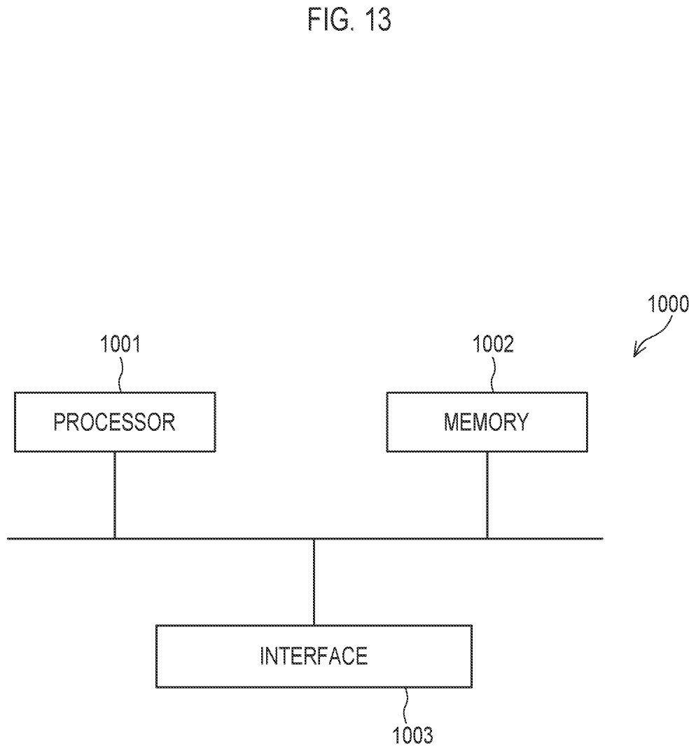

In addition, each device provided in the transport system, such as the control computer 101 of the mobile robot 100, the host management device 2, or the user terminal device 300 according to the embodiment can have, for example, a hardware configuration described below. Alternatively, the joystick device provided in the mobile robot 100, the user terminal device 300, or the like can also have the following hardware configuration. FIG. 13 is a diagram illustrating an example of the hardware configuration of the device.

A device 1000 illustrated in FIG. 13 can be provided with a processor 1001, a memory 1002, and an interface 1003. The interface 1003 can include, for example, a communication interface, an interface with a driving unit, a sensor, an input/output device, or the like that is needed depending on the device.

The processor 1001 may be, for example, an MPU, a CPU, or a graphics processing unit (GPU). The processor 1001 may include a plurality of processors. The memory 1002 is configured with, for example, a combination of a volatile memory and a non-volatile memory. The function of each device is realized by the processor 1001 reading the program stored in the memory 1002 and executing the program while exchanging needed information through the interface 1003.

In addition, the program includes an instruction group (or software code) for causing a computer to execute one or more functions described in the embodiment in a case where the program is read into the computer. The program may be stored on a non-transitory computer-readable medium or a tangible storage medium. Examples of the computer-readable medium or the tangible storage medium include a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disc storages, and a magnetic cassette, a magnetic tape, a magnetic disk storage or other magnetic storage devices, but the computer-readable medium or the tangible storage medium is not limited to these examples. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to these examples.

The present disclosure is not limited to the embodiment, and can be appropriately modified without departing from the spirit.

What is claimed is:

1. A control system configured to execute system control of controlling a system including a mobile robot configured to autonomously move and transport a transport object, wherein:
the mobile robot is provided with a contact portion configured to come into contact with the transport object in a case where the transport object is mounted and transported, and is configured to move based on a movement operation received by an operation interface;
the control system includes one or more processors;
the one or more processors are configured to execute the system control;
the system control includes light emission control of causing a light emission unit including a first light emission unit disposed in a surrounding of the contact portion and a second light emission unit disposed on the operation interface or in a surrounding of the operation interface, to emit light in different light emission patterns associated with each of a plurality of predetermined conditions; and
the light emission control includes control of linking a first light emission pattern that is a light emission pattern in the first light emission unit with a second light emission pattern that is a light emission pattern in the second light emission unit.

2. The control system according to claim 1, wherein the light emission control includes:
synchronization control of emitting light in the first light emission pattern and the second light emission pattern that are associated with a first condition among the predetermined conditions synchronously with each other;
first asynchronization control of emitting light in the first light emission pattern associated with a second condition among the predetermined conditions asynchronously with the second light emission pattern; and
second asynchronization control of emitting light in the second light emission pattern associated with a third condition among the predetermined conditions asynchronously with the first light emission pattern.

3. The control system according to claim 2, wherein the light emission control includes control of switching between the synchronization control, the first asynchronization control, and the second asynchronization control in accordance with the predetermined conditions.

4. The control system according to claim 2, wherein the system control includes control of changing the first condition, the second condition, and the third condition.

5. The control system according to claim 2, wherein the system control includes control of changing the first light emission pattern and the second light emission pattern used in each of the synchronization control, the first asynchronization control, and the second asynchronization control.

6. The control system according to claim 2, wherein the synchronization control is control of emitting light such that the first light emission pattern and the second light emission pattern are light emission patterns having a mutual complementary relationship.

7. The control system according to claim 1, wherein:
the operation interface is provided in the mobile robot; and
the one or more processors are included in a controller provided in the operation interface, or included in a controller provided in a portion of the mobile robot other than the operation interface, or included in a server provided as a part of the system to be connected to the mobile robot through wireless communication.

8. The control system according to claim 1, wherein:
the operation interface is a remote operation device configured to be connected to the mobile robot through wireless communication; and
the one or more processors are configured to execute the light emission control based on a control signal output by a controller provided in the remote operation device for the light emission control, or the one or more processors are included in a controller provided in the mobile robot or a server provided as a part of the system to be connected to the mobile robot through wireless communication.

9. The control system according to claim 1, wherein the operation interface is a joystick device.

10. A control method of executing system control of controlling a system including a mobile robot configured to autonomously move and transport a transport object, wherein:
the mobile robot is provided with a contact portion configured to come into contact with the transport object in a case where the transport object is mounted and transported, and is configured to move based on a movement operation received by an operation interface;
the system control includes light emission control of causing a light emission unit including a first light emission unit disposed in a surrounding of the contact portion and a second light emission unit disposed on the operation interface or in a surrounding of the operation interface, to emit light in different light emission patterns associated with each of a plurality of predetermined conditions; and
the light emission control includes control of linking a first light emission pattern that is a light emission pattern in the first light emission unit with a second light emission pattern that is a light emission pattern in the second light emission unit.

11. The control method according to claim 10, wherein the light emission control includes:
synchronization control of emitting light in the first light emission pattern and the second light emission pattern that are associated with a first condition among the predetermined conditions synchronously with each other;
first asynchronization control of emitting light in the first light emission pattern associated with a second condition among the predetermined conditions asynchronously with the second light emission pattern; and
second asynchronization control of emitting light in the second light emission pattern associated with a third condition among the predetermined conditions asynchronously with the first light emission pattern.

12. The control method according to claim 11, wherein the light emission control includes control of switching between the synchronization control, the first asynchronization control, and the second asynchronization control in accordance with the predetermined conditions.

13. The control method according to claim 11, wherein the system control includes control of changing the first condition, the second condition, and the third condition.

14. The control method according to claim 11, wherein the system control includes control of changing the first light emission pattern and the second light emission pattern used in each of the synchronization control, the first asynchronization control, and the second asynchronization control.

15. The control method according to claim 11, wherein the synchronization control is control of emitting light such that the first light emission pattern and the second light emission pattern are light emission patterns having a mutual complementary relationship.

16. The control method according to claim 10, wherein:
the operation interface is provided in the mobile robot; and
a controller provided in the operation interface, a controller provided in a portion of the mobile robot other than the operation interface, or a server provided as a part of the system to be connected to the mobile robot through wireless communication outputs a control signal for the light emission control.

17. The control method according to claim 10, wherein:
the operation interface is a remote operation device configured to be connected to the mobile robot through wireless communication; and
the light emission control is executed based on a control signal output by a controller provided in the remote operation device for the light emission control, or a controller provided in the mobile robot or a server provided as a part of the system to be connected to the mobile robot through wireless communication outputs a control signal for the light emission control.

18. The control method according to claim 10, wherein the operation interface is a joystick device.

19. A non-transitory storage medium storing instructions that are executable by one or more processors and that cause the one or more processors to execute system control of controlling a system including a mobile robot configured to autonomously move and transport a transport object, wherein:
the mobile robot is provided with a contact portion configured to come into contact with the transport object in a case where the transport object is mounted and transported, and is configured to move based on a movement operation received by an operation interface;
the system control includes light emission control of causing a light emission unit including a first light emission unit disposed in a surrounding of the contact portion and a second light emission unit disposed on the operation interface or in a surrounding of the operation interface, to emit light in different light emission patterns associated with each of a plurality of predetermined conditions; and
the light emission control includes control of linking a first light emission pattern that is a light emission pattern in the first light emission unit with a second light emission pattern that is a light emission pattern in the second light emission unit.

20. The non-transitory storage medium according to claim 19, wherein the light emission control includes:
synchronization control of emitting light in the first light emission pattern and the second light emission pattern that are associated with a first condition among the predetermined conditions synchronously with each other;
first asynchronization control of emitting light in the first light emission pattern associated with a second condition among the predetermined conditions asynchronously with the second light emission pattern; and
second asynchronization control of emitting light in the second light emission pattern associated with a third condition among the predetermined conditions asynchronously with the first light emission pattern.
